(19) United States
(12) Patent Application Publication
(10) Pub. No.: US 2019/0042456 A1
(43) Pub. Date: Feb. 7, 2019

(54) MULTIBANK CACHE WITH DYNAMIC CACHE VIRTUALIZATION

(71) Applicant: Intel Corporation, Santa Clara, CA (US)

(72) Inventors: Yakov Evgeni Ginzburg, Petah Tikva (IL); Naru Dames Sundar, Los Gatos, CA (US); Chih-Jen Chang, Union City, CA (US); Amir Keren, Raanana (IL); Ravi Tangirala, San Jose, CA (US)

(73) Assignee: Intel Corporation, Santa Clara, CA (US)

(21) Appl. No.: 16/021,319

(22) Filed: Jun. 28, 2018

(51) Int. Cl. G06F 12/0893; G06F 12/084; G06F 12/1018; G06F 9/455

(52) U.S. Cl. CPC G06F 12/0893; G06F 12/084; G06F 12/1018; G06F 9/45558; G06F 2212/657; G06F 2009/45583; G06F 2009/45587; G06F 2212/283; G06F 2009/45595

(57) ABSTRACT

There is disclosed in one example a computing system, including: a processor including one or more computing cores; a cache having n discrete cache banks of the same cache level; and a cache controller including n discrete cache buses to communicatively couple the cache controller to the cache, wherein the cache buses are of width b, and a cache access controller configured to: receive an access request for an object of size s, wherein s>b; divide the object into k chunks of size b or smaller; and transfer the object to or from the cache in one or more iterations, the iterations including transferring n chunks of size b or smaller in parallel via the cache buses.

### FIELD OF THE SPECIFICATION

This disclosure relates in general to the field of virtualized computing, and more particularly, though not exclusively, to a system and method for providing a multibank cache with dynamic cache virtualization.

### BACKGROUND

In some modern data centers, the function of a device or appliance may not be tied to a specific, fixed hardware configuration. Rather, processing, memory, storage, and accelerator functions may in some cases be aggregated from different locations to form a virtual “composite node.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a hardware platform configured to host a plurality of virtual machines (VMs), according to one or more examples of the present specification.

FIG. 2 is a block diagram illustrating mapping between a VM and a cache, according to one or more examples of the present specification.

FIG. 3 is a block diagram illustrating the construction of a hash memory space ID (HMS ID), according to one or more examples of the present specification.

FIGS. 4a and 4b are a block diagram illustrating translation between an object virtual address and an object physical address, according to one or more examples of the present specification.

FIG. 5 is a flowchart of a method of performing dynamic cache virtualization, according to one or more examples of the present specification.

FIG. 6 is a flowchart of a method that may be performed by a cache access element of a cache controller or cache engine, according to one or more examples of the present specification.

FIG. 7 is a block diagram of selected components of a data center with connectivity to a network of a cloud service provider (CSP), according to one or more examples of the present specification.

FIG. 8 is a block diagram of selected components of an end-user computing device, according to one or more examples of the present specification.

FIG. 9 is a block diagram of a network function virtualization (NFV) architecture, according to one or more examples of the present specification.

FIG. 10 is a block diagram of components of a computing platform, according to one or more examples of the present specification.

FIG. 11 is a block diagram of a central processing unit (CPU), according to one or more examples of the present specification.

FIG. 12 is a block diagram of rack scale design (RSD), according to one or more examples of the present specification.

FIG. 13 is a block diagram of a software-defined infrastructure (SDI) data center, according to one or more examples of the present specification.

FIG. 14 is a block diagram of a container host, according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

A contemporary computing platform, such as a hardware platform provided by Intel® or similar, may include a capability for monitoring device performance and making decisions about resource provisioning. For example, in a large data center such as may be provided by a cloud service provider (CSP), the hardware platform may include rackmounted servers with compute resources such as processors, memory, storage pools, accelerators, and other similar resources. As used herein, “cloud computing” includes network-connected computing resources and technology that enables ubiquitous (often worldwide) access to data, resources, and/or technology. Cloud resources are generally considered as separate from an enterprise data center, and characterized by great flexibility to dynamically assign resources according to current workloads and needs. This can be accomplished, for example, via virtualization, wherein resources such as hardware, storage, and networks are provided to a virtual machine (VM) via a software abstraction layer, and/or containerization, wherein instances of network functions are provided in “containers” that are separated from one another, but that share underlying operating system, memory, and driver resources.

As disclosed in the present specification, a processor includes any programmable logic device with an instruction set. Processors may be real or virtualized, local or remote, or in any other configuration. A processor may include, by way of nonlimiting example, an Intel® processor (e.g., Xeon®, Core™, Pentium®, Atom®, Celeron®, x86, or others). A processor may also include competing processors, such as AMD (e.g., Kx-series x86 workalikes, or Athlon, Opteron, or Epyc-series Xeon workalikes), ARM processors, or IBM PowerPC and Power ISA processors, to name just a few.

As further disclosed in the present specification, a VM is an isolated partition within a computing device that allows usage of an operating system and other applications, independent of other programs on the device in which it is contained. VMs, containers, and similar may be generically referred to as “guest” systems.

In computing systems that require low latency, the correct management of caches can be a premium concern. Cache design must deal with competing demands. For example, a larger cache can cache more data than a smaller cache, thus reducing the likelihood of a cache miss. On the other hand, large caches are expensive, and as the size of a cache increases, the distance between physical elements also increases, which reduces the operational speed of the cache.

Many contemporary computing systems address this issue by providing caches at various “levels.” For example, the Level 1 (L1) cache, also referred to as the “last level cache” (LLC), is generally the smallest and the fastest cache. The next level of cache in the cache hierarchy, Level 2 (L2) may be larger and slower than the L1 cache. Furthermore, in some cases, the L2 cache may be shared by two or more cores, particularly two or more cores located on the same physical die. For example, in a multicore and multiprocessor system, each core may have its own individual L1 cache or LLC. Each pair of cores, or alternately, each group of cores on a single physical die, may share an L2 cache. The motherboard may provide a Level 3 (L3) cache, which is commonly shared by all CPU sockets hosted in that motherboard. The L3 cache is larger and less expensive per data unit than the L2 and L1 caches, respectively, but smaller, faster, and more expensive per unit than the much larger main memory, which may be populated by dynamic random access memory (DRAM) dual inline memory modules (DIMMs).

The present specification discloses an architecture wherein a plurality of cache banks are provided at the same level of cache. An L1 cache is used throughout the present specification as an illustrative embodiment of the teachings herein. However, where a cache is mentioned and treated as an L1 cache throughout the following detailed description, that cache should be understood to stand for any level of cache in the cache hierarchy. Specifically, a plurality of cache banks as taught herein can be used at L1, L2, and/or L3.

Embodiments of the present specification include architectures in which a cache physically includes a plurality of cache banks. For example, the L1 cache may be divided into four individual cache banks. Whereas a common single-bank cache may include a single 128-byte bus, the separate cache banks of the present specification may each include their own separate buses, which can be read from or written to, in parallel. For example, rather than providing a single 128-byte cache bus, an embodiment may include four individual cache banks, each including its own 64-byte bus.

As used in the present specification, an object is a memory construct for storing data that are related to one another and that may be usefully structured together. In embodiments disclosed herein, an object as small as 64 bytes can be written to a cache bank without underutilizing that cache bus. Alternately, an object as large as 256 bytes can be written to cache in a single bus transaction, or a larger object can be divided into 256-byte blocks and written to cache 256 bytes at a time.

In examples where an object is written to a plurality of cache banks via a plurality of cache buses, that object may span two or more of the cache banks. Thus, a cache controller (such as a caching home agent (CHA)) may be configured to store the start address of the cached object, and to appropriately read cached objects from the plurality of cache banks. As used in the present disclosure, a CHA includes hardware and/or software that acts on behalf of a user within a computer cache memory architecture.

The teachings of the present specification have beneficial properties in relation to virtualized computing. In virtualized computing requirements, it may be necessary to cache different parts of data structures or objects that belong to various virtual machines. Because virtual machines can be dynamically established or added (e.g., “spun up”), and deleted or removed (e.g., “spun down”), or be moved within the data center, conventional caching schemes can run into limitations. A conventional caching scheme may employ a virtual-to-physical address translation scheme that is preallocated per virtual machine, with a fixed and identical allocation size for all objects. This can result in inefficient memory use. The multibank caching mechanism of the present specification allows for individual virtual address space per virtual machine, as well as a dynamic allocation of cache banks for caching different objects of various sizes across the various virtual machines.

Existing systems often implement a fixed cache line size for caching objects belonging to different virtual machines and a virtual-to-physical address mapping scheme that is wholly dependent on that fixed cache line size. The virtual machine memory is preallocated to different segments of the address space. But the use of a fixed cache line size for different types of objects may result in inefficient use of the cache memory, which may typically be located on-chip in the case of L1 or L2 cache. Furthermore, the virtual address space used by a virtual machine is preallocated, which also results in inefficient use of memory.

Advantageously, the caching mechanism of the present specification uses a virtual machine ID and object ID within the virtual machine to index to a virtual address table to obtain a virtual address space ID, cache entry size, first cache bank, and number of cache banks used. Each cache bank word line can be implemented to a minimum object size granularity, and the length of an object can include multiple cache banks with one cache tag. The object store for a virtual machine may be dynamically allocated. This allows users to manage objects of variable sizes belonging to different virtual machines, each within its own dedicated virtual address space. This caching scheme also enables dynamic allocation of objects in memory, as well as the use of multiple cache banks to achieve better memory efficiency and higher throughput. Ultimately, this results in lower latency in computational operations, and better computing systems. This is particularly advantageous in data centers, wherein a large number of virtual machines may operate on a single physical hardware platform.

A system and method for providing a multibank cache with dynamic cache virtualization will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

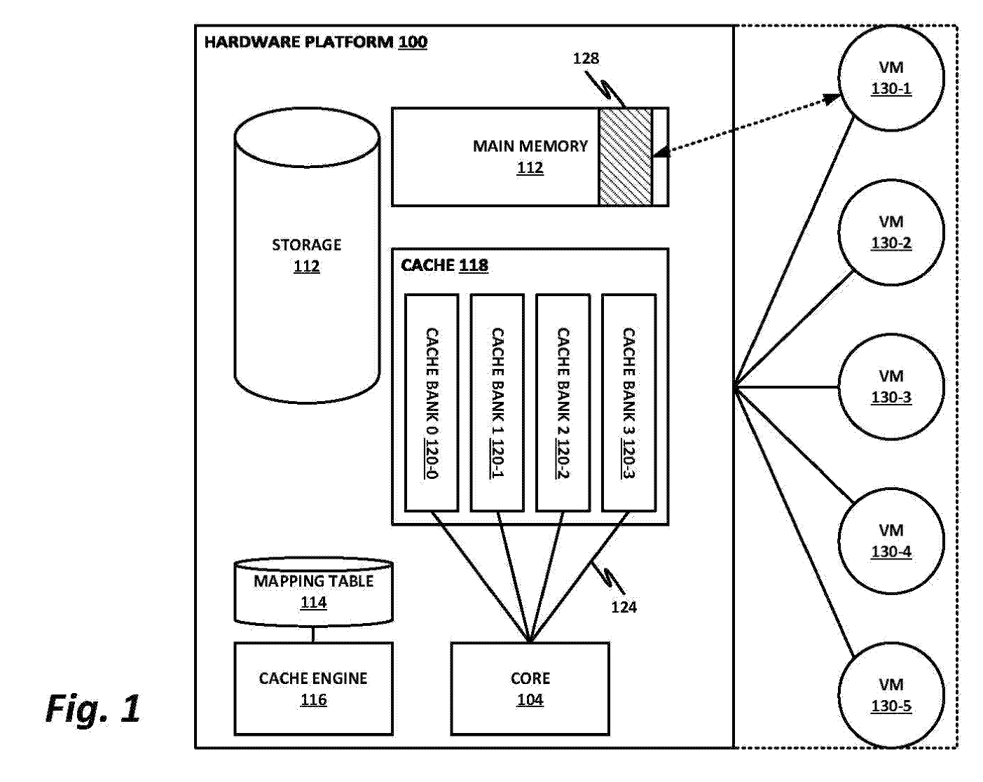

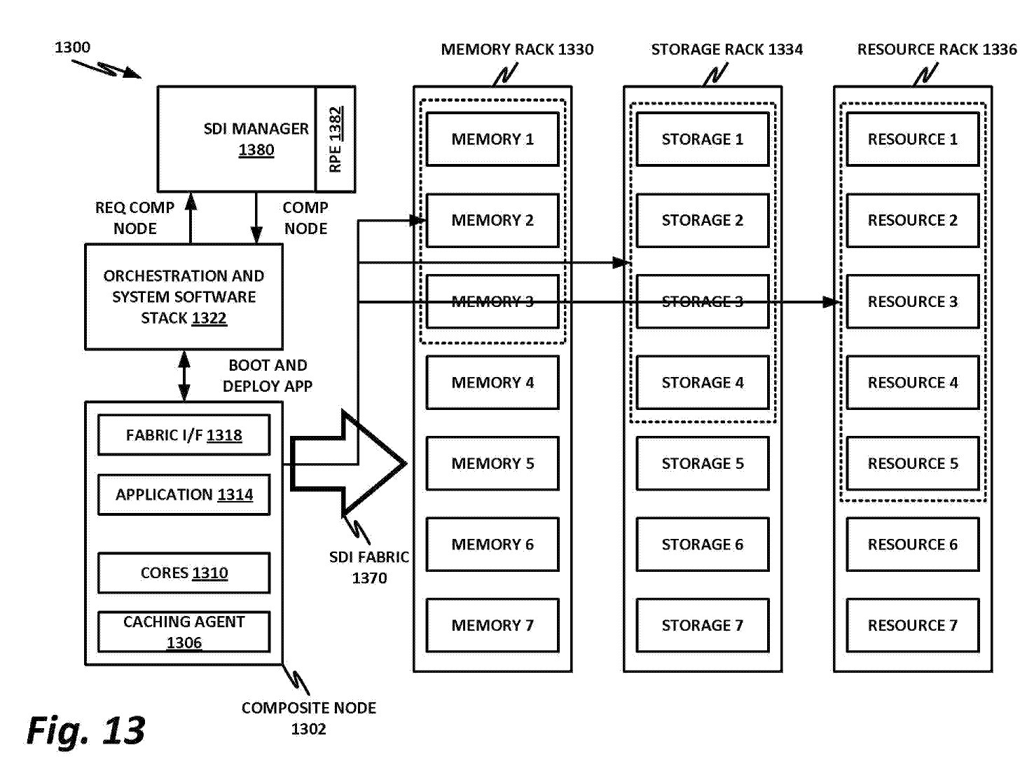

FIG. 1 is a block diagram of a hardware platform configured to host a plurality of VMs, according to one or more examples of the present specification. FIG. 1 includes a hardware platform 100. Hardware platform 100 is shown here as a discrete hardware platform. For example, a rackmount server may fit within a 1 U slot of a server chassis, and may include the elements shown on hardware platform 100. But, as illustrated in FIG. 13, a hardware platform could also include disaggregated resources communicatively coupled via high speed interconnects.

In this example, hardware platform 100 includes one or more cores 104. For example, a common rackmount server includes up to 24 cores. Hardware platform 100 also includes a storage 112, which may include an operating system, a hypervisor, a virtual machine manager, or other support functions for allocating and managing one or more virtual machines 130.

Hardware platform 100 also includes a main memory 112, with one or more associated caches 118. In this case, cache 118 is illustrated as servicing a plurality of cores 104. But cache 118 could be any one of an L1, L2, L3, or other cache level within a cache hierarchy. For ease of illustration, throughout the remainder of this example, core 104 will be treated as a single core, in which case cache 118 may be an L1 cache. But the teachings of this specification should be understood to apply also to other levels of cache.

Hardware platform 100 also includes a cache engine 116, having associated therewith a mapping table 114. Mapping table 114 could be a page table, an extended page table, or a similar structure. Cache engine 116 may be, for example, a CHA, a cache controller, or other element that provides control to cache 118. In some embodiments, cache engine 116 could include multiple parts. For example, it could include logic for performing address translation between a VM and cache 118. It could also include a cache controller that performs low-level cache access operations between core 104 and cache banks 120 within cache 118.

Cache 118 includes a plurality of cache banks 120. In this example, cache bank 0 120-0, cache bank 1 120-1, cache bank 2 120-2, and cache bank 3 120-3 are provided within cache 118. Cache banks 120 may be essentially independent, interleaved, or otherwise associated. In some cases, different cache banks 120 may be associated with specific cache ways, while in other examples, greater flexibility may be provided. Each cache bank 120 may communicatively couple to core 104 via a cache bus 124. As discussed above, while a legacy cache may include a 128-byte cache bus, in this case, each cache bus 124 may be 64 bytes. However, this designation of specific sizes of cache bus 124 is provided by way of nonlimiting example only. The values are provided specifically to illustrate the principle that, in some embodiments, each cache bus 124 may be of a size less than the size a single cache bus would be if that single cache bus were servicing the entirety of cache 118, as in some existing systems. In the aggregate, however, cache buses 124 taken together may provide an overall data bandwidth that is higher than in an existing system. It should also be noted that in other embodiments, the total cache bus bandwidth for a single legacy cache may be divided by the number of cache banks 120, in which case the width of each cache bus 124 would be 1/n the size of the total legacy cache bus. For example, in this illustration, four cache banks 120 are provided. If a legacy cache having a single cache bank had a 128-byte cache bus, then each cache bus 124 in the illustration may be one-fourth of that size, or in other words, 32 bytes. Many other configurations are possible, and the illustration here should be understood as a single nonlimiting example. Throughout the examples disclosed in the FIGURES, four cache buses 120 will be used as an illustrative example, with each cache bus 124 having a width of 64 bytes. This provides a total cache bus capacity of 264 bytes per transfer. However, in the general sense, any number of N cache banks may be provided, while each cache bus may be of size b or smaller. So, generally speaking, the total cache bandwidth may be n×b bytes per transaction. The four-bank cache with 64-byte cache bus per bank illustrated throughout these drawings should be understood to stand for the general class of caches, including n cache banks (wherein n≠1), with each cache bank having a cache bus of size b or smaller.

As illustrated in this FIGURE, a region 128 of main memory 112 may be allocated to a virtual machine. For example, in this illustration, virtual machines 130-1, 130-2, 130-3, 130-4, and 130-5 are allocated on hardware platform 100. Region 128 may be mapped to virtual machine 130-1. Thus, when memory addresses within region 128 are cached to cache 118, those regions of cache are assigned to VM 130-1. Cache engine 116, with the help of mapping table 114, manages these caching transactions.

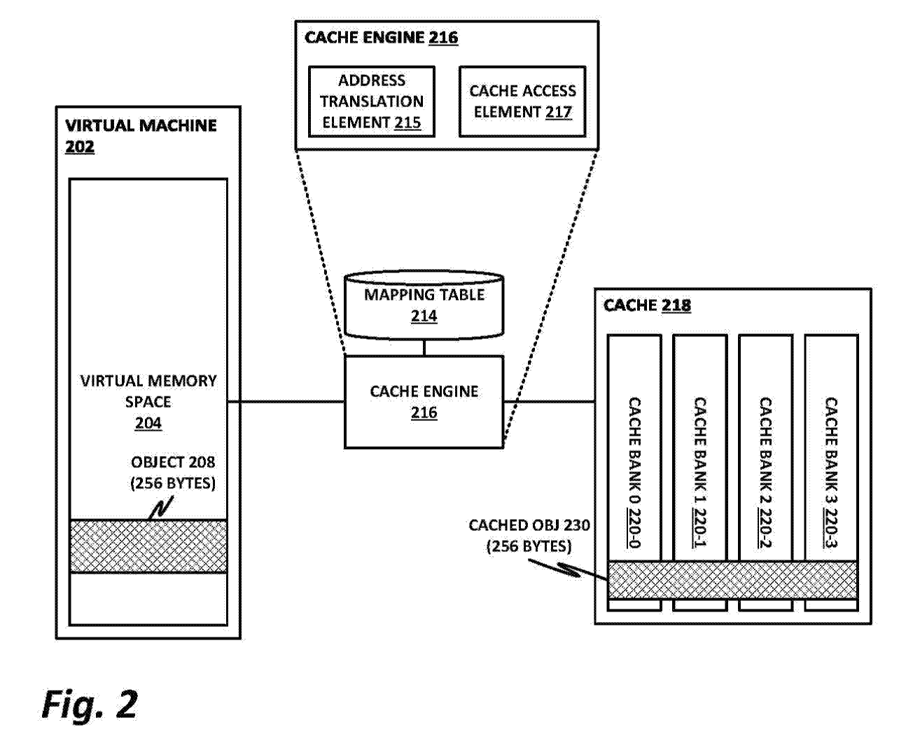

FIG. 2 is a block diagram illustrating mapping between a VM 202 and a cache, according to one or more examples of the present specification. FIG. 2 illustrates an application of the multibank cache of the present specification, with particular reference to a VM 202.

In this case, VM 202 includes a virtual memory space 204. Within virtual memory space 204, there is allocated a particular object 208, which in this case has a size of 256 bytes. When VM 202 writes object 208 to memory, caching engine 216, with the help of mapping table 214, may determine that object 208 is to be stored within cache 118. As illustrated in this example, cache 218 includes a plurality of cache banks, namely cache bank 0 220-0, cache bank 1 220-1, cache bank 2 220-2, and cache bank 3 220-3.

Similar to cache engine 116 of FIG. 1, cache engine 216 could include multiple parts. In the embodiment of FIG. 2, it could include an address translation element 215. It could also include a cache access element 217, by way of nonlimiting example. Within the scope of the present specification, address translation element 215 and cache access element 217 could be provided as the same or separate elements within cache engine 216.

As in the illustration of FIG. 1, each cache bank 220 may have a 64-byte cache bus to its processor. So when VM 202 writes out object 208, consisting of 256 bytes of data, and cache engine 216 in consultation with mapping table 214 determines that the object is to be written to cache 218, object 208 can be written in a manner that spans all four cache banks 220.

In this example, VM 202 is given an ID, and each object type to be installed within virtual memory space 204 of virtual machine 202 is also given an assigned identifier (ID). The combination of the virtual machine ID (VM ID) and object type ID (object ID) may be used as an index to a hash memory space ID (HMS ID). This enables cache engine 216 to look up the starting cache bank 220 for the object, and also the object length, and determine if and how it spans a plurality of cache banks 220. This enables cache engine 216 to appropriately write the cache values, as well as to appropriately read out cache values from the plurality of cache banks 220.

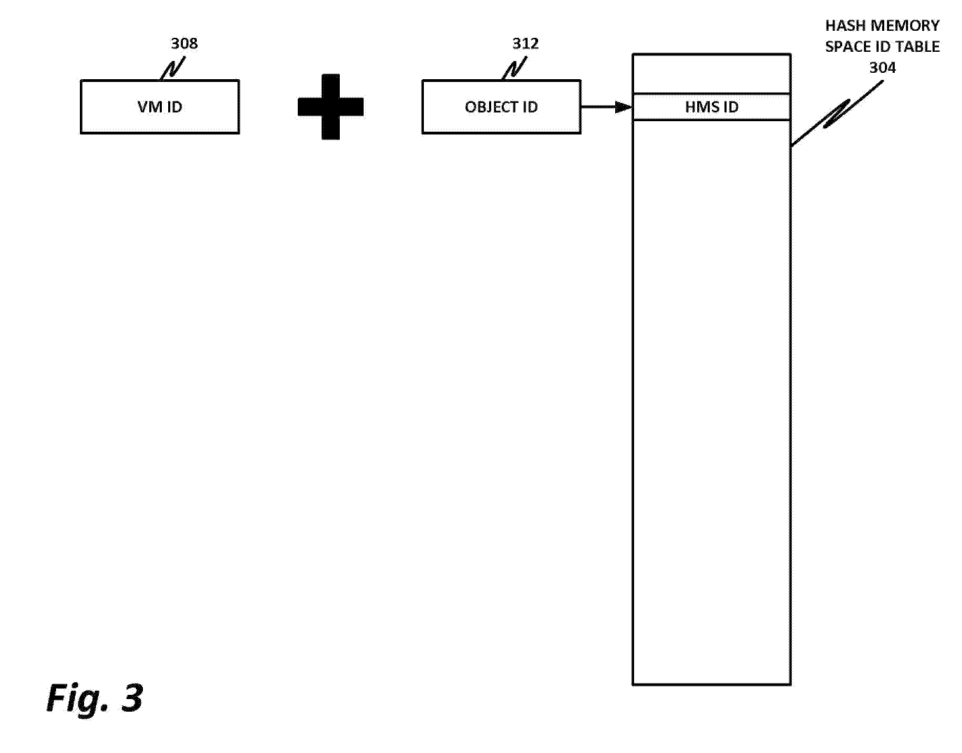

FIG. 3 is a block diagram illustrating the construction of a hash memory space ID (HMS ID), according to one or more examples of the present specification. The operating principle of the caching mechanism illustrated in FIG. 2 is explained in further detail in FIG. 3.

Specifically, a mapping table, such as mapping table 114 of FIG. 1 or mapping table 214 of FIG. 2, may include an HMS ID table 304. When a new object is created, the VM ID 308 and object ID 312 are combined and hashed, and the hash is used as an index into the HMS ID table 304.

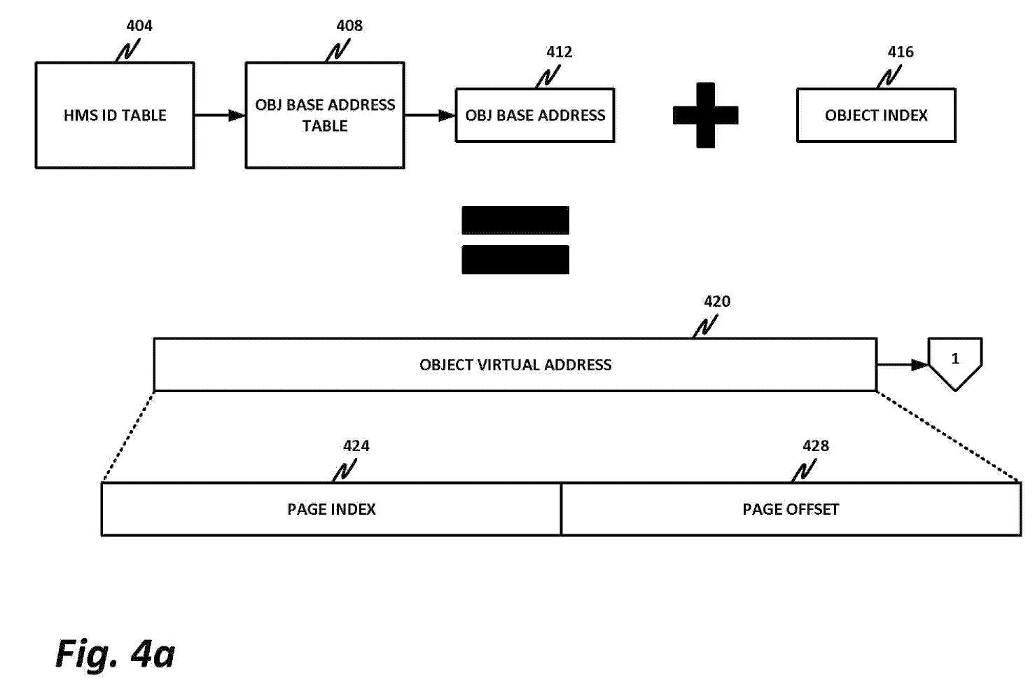

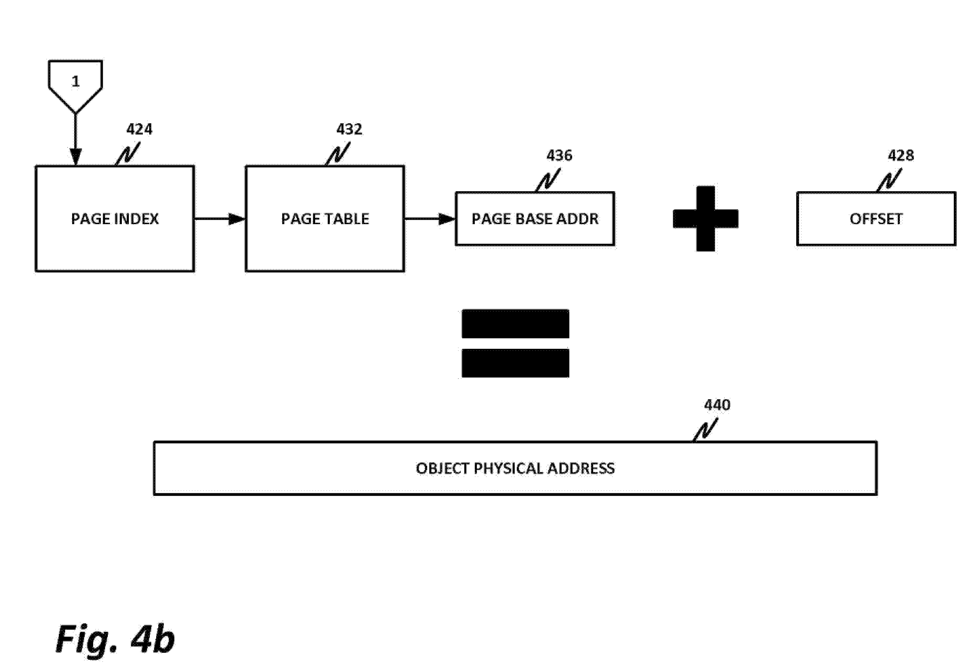

FIGS. 4a and 4b are a block diagram illustrating translation between an object virtual address and an object physical address, according to one or more examples of the present specification. These two FIGURES illustrate translation from HMS ID table 404 to, ultimately, an object physical address 440.

In FIG. 4a, the HMS ID as produced in FIG. 3 is used as an index to an object base address table 408. Object base address table 408 can then produce an object base address 412. An object index 416 may be derived by applying a hash algorithm to the object. The object base address 412 derived from object base address table 408 is combined with object index 416. This yields the overall object virtual address 420, comprising a page index 424 and a page offset 428.

Following off-page connector 1 to FIG. 4b, page index 424 of the object virtual address 420 may be used as an index to a page table 424, which is used to look up the physical base address for the object. This yields a page base address 436 for the object within virtual memory. Page base address 436 plus page offset 428 of object virtual address 420 may then be used to find the final object physical address 440 of the object.

With this scheme, each object type associated with a virtual machine has its own address space, and can be allocated dynamically on a per-page granularity when new objects are to be installed in memory. The plurality of cache banks, as illustrated in FIG. 200, can then be used for caching the objects. The caching mechanism may include a profile table, which can be indexed by the object ID to look up the object entry size, first cache bank, and number of cache banks to use for caching the object. These data can be included within mapping table 214, accessible by cache engine 216.

A cache such as cache 218 comprising multiple cache banks, with each cache of the same size, allows a single object to be stored across multiple cache banks to make up the total word line size of the object.

When software adds an object entry to the memory, the cache structure provides a write through mechanism, which installs the object entry in the cache as well as the backing memory. The object entry may be installed in the cache, based on the profile table lookup for the object type. Objects of the same entry size can share the same cache bank or plurality of cache banks, while software is free to allocate cache banks to different object types based on the object profile. This can achieve efficient memory utilization.

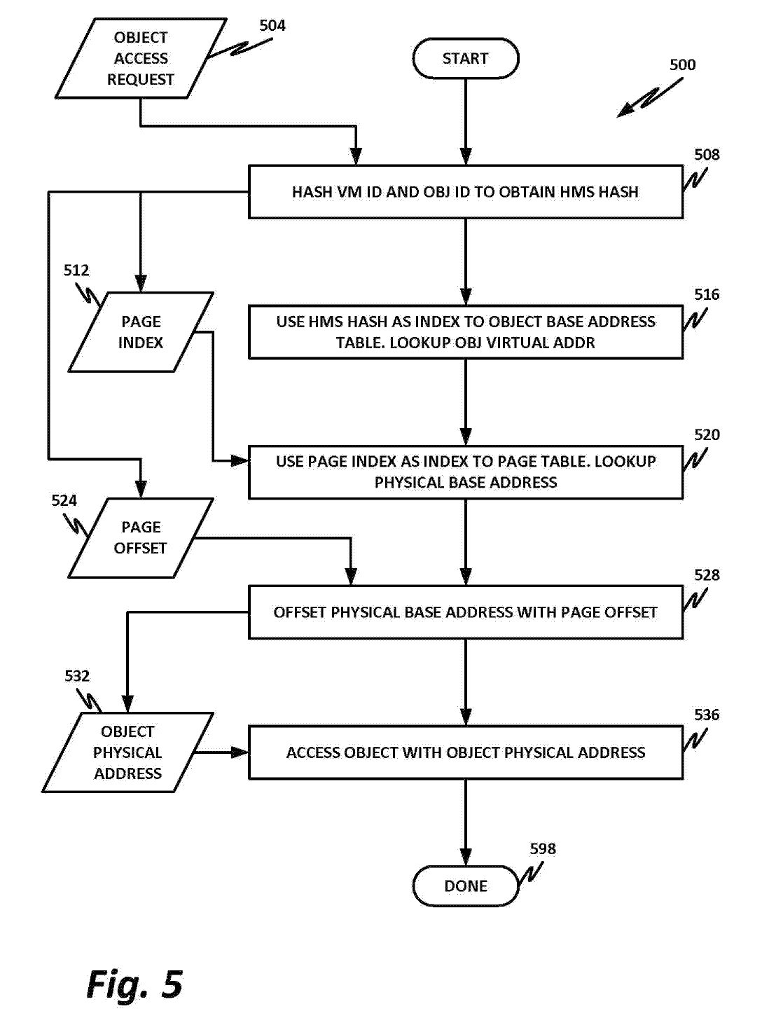

FIG. 5 is a flowchart of a method 500 of performing dynamic cache virtualization, according to one or more examples of the present specification. Address translation may be provided by an address translation engine, address translation element, address translation circuit, or other address translation logic within a cache engine 116.

In block 508, the address translation element receives an object access request 504. This requests either a read or write address to a particular object in the cache. The address translation element hashes the VM ID and object ID to obtain an HMS hash. The HMS hash includes a page index 512 and a page offset 524.

In block 516, the address translation uses the hash as an index to the object base address table. It uses this to look up the object virtual address.

In block 520, the address translation element uses page index 512 as an index into the page table. It uses this to look up the physical base address from the object virtual address.

In block 528, the address translation element offsets the physical base address with page offset 524 to obtain an object physical address 532.

In block 536, the translation element uses object physical address 532 to access the object at its physical address. For example, the address translation element may provide the object physical address to a cache access element, which performs the actual cache access. In block 598, the method is done.

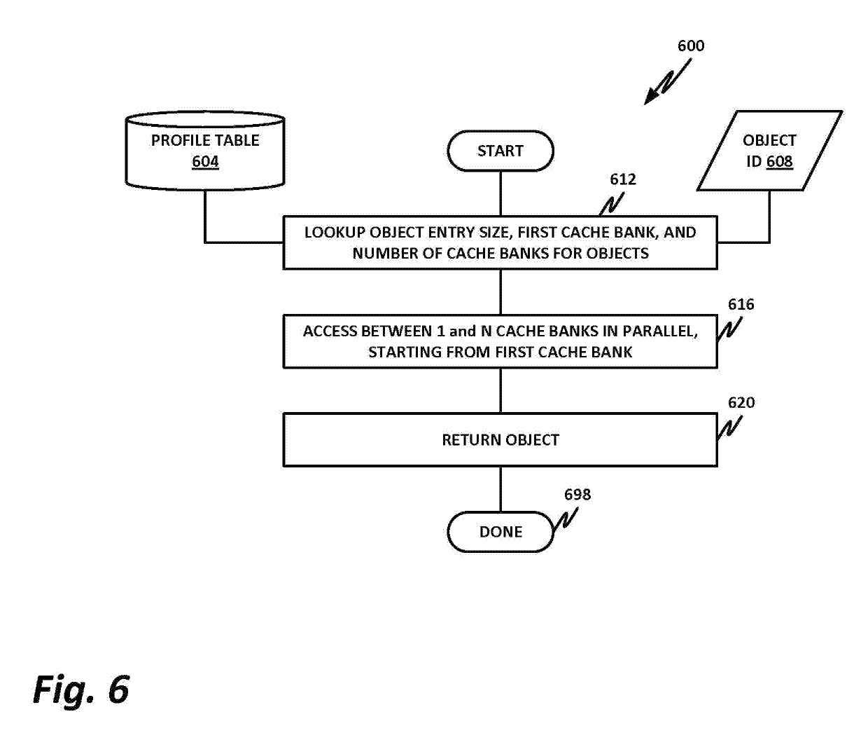

FIG. 6 is a flowchart of a method 600 that may be performed by a cache access element of a cache controller or cache engine, according to one or more examples of the present specification. The cache controller or cache engine of FIG. 6 may provide the cache control functions of cache engine 116 of FIG. 1, by way of nonlimiting example. Note that in various embodiments, an address translation element and a cache access element may be provided in separate functions or separate physical units. In other embodiments, address translation and cache access may be provided in a single physical element.

In block 612, the cache access element receives an object ID 608, and uses object ID 608 to look up, in profile table 604, the object entry size, first cache bank, and number of cache banks for the object.

In block 616, the cache access element accesses between 1 and N cache banks in parallel, starting from the first cache bank. For example, if the object is a 256-byte object and each cache bank has a 64-byte cache bus, then the cache access element may retrieve a 64-byte cache line from each cache bank within the cache. Note that in some embodiments, these cache lines need not be at the same offset within each cache bank. In particular, if the first cache bank is, for example, bank 2 at offset x, then the next byte may be stored in bank 3 at offset x. However, it is possible that offset x is already occupied in banks 0 and 1. Thus, the remainder of the object may be stored at offset x+1 in banks 0 and 1. Furthermore, embodiments are possible in which elements are stored in an available offset within a cache bank, without reference to which offset the object is stored in at other cache banks. In this case, the cache banks may be treated similar to independent random access memory banks, and each memory access operation would require a separate offset for each cache bank. This flexibility may be desirable in some applications, while in other applications it may be more desirable to have a model in which objects are stored in contiguous addresses, so that only the offset of the starting bank and the number of banks needs to be specified in an object access request.

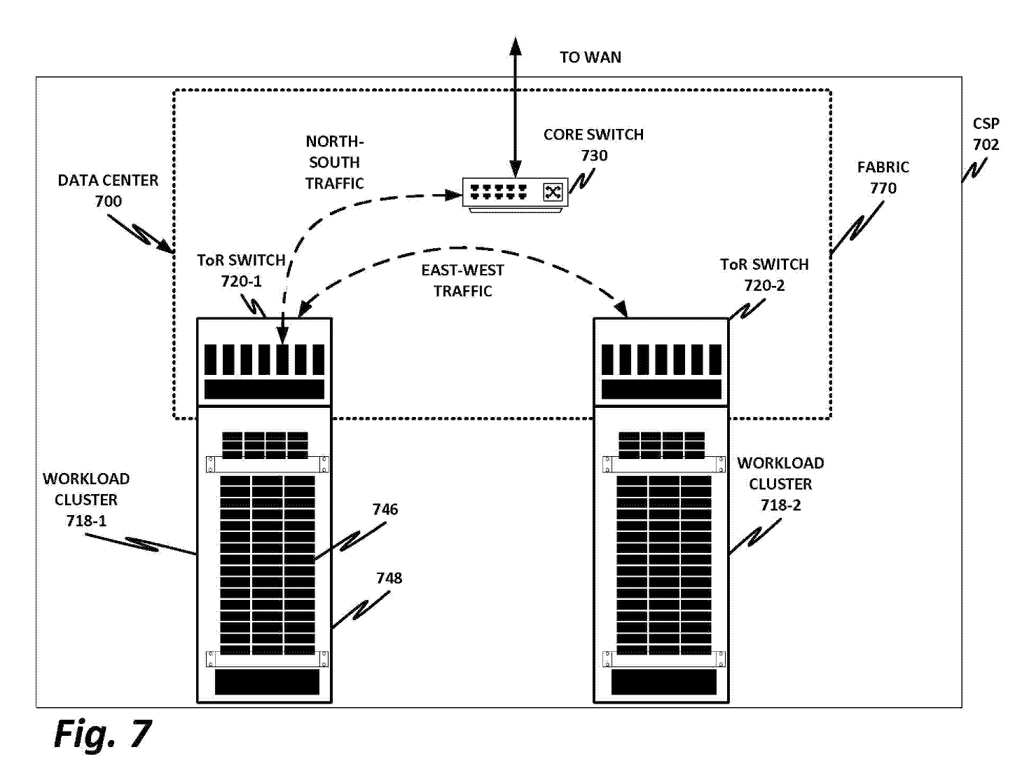

FIG. 7 is a block diagram of selected components of a data center with connectivity to network 700 of a CSP 702, according to one or more examples of the present specification. Embodiments of a data center with network connectivity disclosed herein may be adapted or configured to provide the method of providing a multibank cache with dynamic cache virtualization, according to the teachings of the present specification.

CSP 702 may be, by way of nonlimiting example, a traditional enterprise data center, an enterprise “private cloud,” or a “public cloud,” providing services such as infrastructure as a service (IaaS), platform as a service (PaaS), or software as a service (SaaS). In some cases, CSP 702 may provide, instead of or in addition to cloud services, high-performance computing (HPC) platforms or services. Indeed, while not expressly identical, HPC clusters (“supercomputers”) may be structurally similar to cloud data centers, and unless and except where expressly specified, the teachings of this specification may be applied to either. In general usage, the “cloud” is considered to be separate from an enterprise data center. Whereas an enterprise data center may be owned and operated on-site by an enterprise, a CSP provides third-party compute services to a plurality of “tenants.” Each tenant may be a separate user or enterprise, and may have its own allocated resources, SLAs, and similar.

CSP 702 may provision some number of workload clusters 718, which may be clusters of individual servers, blade servers, rackmount servers, or any other suitable server topology. In this illustrative example, two workload clusters, 718-1 and 718-2 are shown, each providing rackmount servers 746 in a chassis 748.

In this illustration, workload clusters 718 are shown as modular workload clusters conforming to the rack unit (“U”) standard, in which a standard rack, 19 inches wide, may be built to accommodate 42 units (42 U), each 1.75 inches high and approximately 36 inches deep. In this case, compute resources such as processors, memory, storage, accelerators, and switches may fit into some multiple of rack units from one to 42.

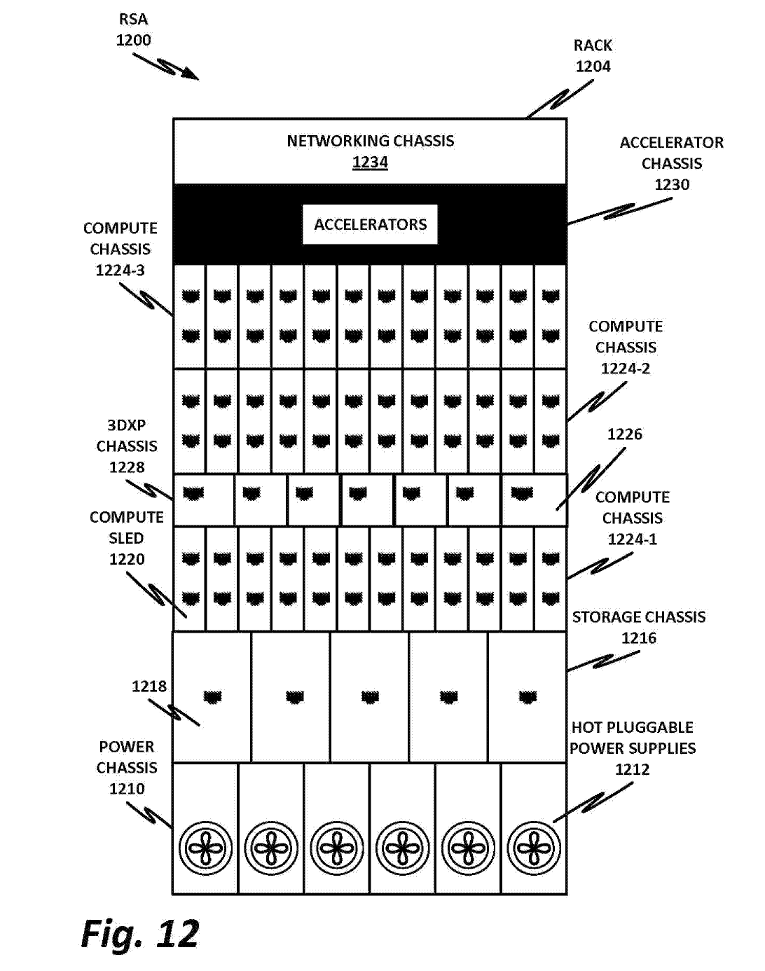

However, other embodiments are also contemplated. For example, FIG. 12 illustrates a resource sled. While the resource sled may be built according to standard rack units (e.g., a 3 U resource sled), it is not necessary to do so in so-called “rack scale” design. In that case, entire pre-populated racks of resources may be provided as a unit, with the rack hosting a plurality of compute sleds, which may or may not conform to the rack unit standard (particularly in height). In those cases, the compute sleds may be considered “line replaceable units” (LRUs). If a resource fails, the sled hosting that resource can be pulled, and a new sled can be modularly inserted. The failed sled can then be repaired or discarded, depending on the nature of the failure. Rack scale design is particularly useful in the case of software-defined infrastructure (SDI), wherein composite nodes may be built from disaggregated resources. Large resource pools can be provided, and an SDI orchestrator may allocate them to composite nodes as necessary.

Each server 746 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 746 may be specifically dedicated to certain enterprise clients or tenants, while others may be shared.

The various devices in a data center may be connected to each other via a switching fabric 770, which may include one or more high speed routing and/or switching devices. Switching fabric 770 may provide both “north-south” traffic (e.g., traffic to and from the wide area network (WAN), such as the Internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 746 increases, traffic volume may further increase. For example, each server 746 may provide multiple processor slots, with each slot accommodating a processor having four to eight cores, along with sufficient memory for the cores. Thus, each server may host a number of VMs, each generating its own traffic.

To accommodate the large volume of traffic in a data center, a highly capable switching fabric 770 may be provided. Switching fabric 770 is illustrated in this example as a “flat” network, wherein each server 746 may have a direct connection to a top-of-rack (ToR) switch 720 (e.g., a “star” configuration), and each ToR switch 720 may couple to a core switch 730. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 746 may include an Intel® Host Fabric Interface (HFI), a network interface card (NIC), a host channel adapter (HCA), or other host interface. For simplicity and unity, these may be referred to throughout this specification as a “host fabric interface” (HFI), which should be broadly construed as an interface to communicatively couple the host to the data center fabric. The HFI may couple to one or more host processors via an interconnect or bus, such as PCI, PCIe, or similar. In some cases, this interconnect bus, along with other “local” interconnects (e.g., core-to-core Ultra Path Interconnect) may be considered to be part of fabric 770. In other embodiments, the Ultra Path Interconnect (UPI) (or other local coherent interconnect) may be treated as part of the secure domain of the processor complex, and thus not part of the fabric.

The interconnect technology may be provided by a single interconnect or a hybrid interconnect, such as where PCIe provides on-chip communication, 1 Gb or 10 Gb copper Ethernet provides relatively short connections to a ToR switch 720, and optical cabling provides relatively longer connections to core switch 730. Interconnect technologies that may be found in the data center include, by way of nonlimiting example, Intel® silicon photonics, an Intel® HFI, a NIC, intelligent NIC (iNIC), smart NIC, an HCA or other host interface, PCI, PCIe, a core-to-core UPI (formerly called QPI or KTI), Infinity Fabric, Intel® Omni-Path™ Architecture (OPA), TrueScale™, FibreChannel, Ethernet, FibreChannel over Ethernet (FCoE), InfiniBand, a legacy interconnect such as a local area network (LAN), a token ring network, a synchronous optical network (SONET), an asynchronous transfer mode (ATM) network, a wireless network such as WiFi or Bluetooth, a “plain old telephone system” (POTS) interconnect or similar, a multi-drop bus, a mesh interconnect, a point-to-point interconnect, a serial interconnect, a parallel bus, a coherent (e.g., cache coherent) bus, a layered protocol architecture, a differential bus, or a Gunning transceiver logic (GTL) bus, to name just a few. The fabric may be cache- and memory-coherent, cache- and memory-non-coherent, or a hybrid of coherent and non-coherent interconnects. Some interconnects are more popular for certain purposes or functions than others, and selecting an appropriate fabric for the instant application is an exercise of ordinary skill. For example, OPA and Infiniband are commonly used in HPC applications, while Ethernet and FibreChannel are more popular in cloud data centers. But these examples are expressly nonlimiting, and as data centers evolve fabric technologies similarly evolve.

In embodiments of the present specification, cache coherency is a memory architecture that provides uniform sharing and mapping between a plurality of caches. For example, the caches may map to the same address space. If two different caches have cached the same address in the shared address space, a coherency agent provides logic (hardware and/or software) to ensure the compatibility and uniformity of shared resource. For example, if two caches have cached the same address, when the value stored in that address is updated in one cache, the coherency agent ensures that the change is propagated to the other cache. Coherency may be maintained, for example, via “snooping,” wherein each cache monitors the address lines of each other cache, and detects updates. Cache coherency may also be maintained via a directory-based system, in which shared data are placed in a shared directory that maintains coherency. Some distributed shared memory architectures may also provide coherency, for example by emulating the foregoing mechanisms.

Coherency may be either “snoopy” or directory-based. In snoopy protocols, coherency may be maintained via write-invalidate, wherein a first cache that snoops a write to the same address in a second cache invalidates its own copy. This forces a read from memory if a program tries to read the value from the first cache. Alternatively, in write-update, a first cache snoops a write to a second cache, and a cache controller (which may include a coherency agent) copies the data out and updates the copy in the first cache.

By way of nonlimiting example, current cache coherency models include MSI (modified, shared, invalid), MESI (modified, exclusive, shared, invalid), MOSI (modified, owned, shared, invalid), MOESI (modified, owned, exclusive, shared, invalid), MERSI (modified, exclusive, read-only or recent, shared, invalid), MESIF (modified, exclusive, shared, invalid, forward), write-once, Synapse, Berkeley, Firefly, and Dragon protocols. Furthermore, ARM processors may use advanced microcontroller bus architecture (AMBA), including AMBA 4 ACE, to provide cache coherency in systems-on-a-chip (SoCs) or elsewhere.

Note that while high-end fabrics such as OPA are provided herein by way of illustration, more generally, fabric 770 may be any suitable interconnect or bus for the particular application. This could, in some cases, include legacy interconnects like LANs, token ring networks, synchronous optical networks (SONET), ATM networks, wireless networks such as WiFi and Bluetooth, POTS interconnects, or similar. It is also expressly anticipated that in the future, new network technologies may arise to supplement or replace some of those listed here, and any such future network topologies and technologies can be or form a part of fabric 770.

In certain embodiments, fabric 770 may provide communication services on various “layers,” as originally outlined in the Open Systems Interconnection (OSI) seven-layer network model. In contemporary practice, the OSI model is not followed strictly. In general terms, layers 1 and 2 are often called the “Ethernet” layer (though in some data centers or supercomputers, Ethernet may be supplanted or supplemented by newer technologies). Layers 3 and 4 are often referred to as the transmission control protocol/internet protocol (TCP/IP) layer (which may be further subdivided into TCP and IP layers). Layers 5-7 may be referred to as the “application layer.” These layer definitions are disclosed as a useful framework, but are intended to be nonlimiting.

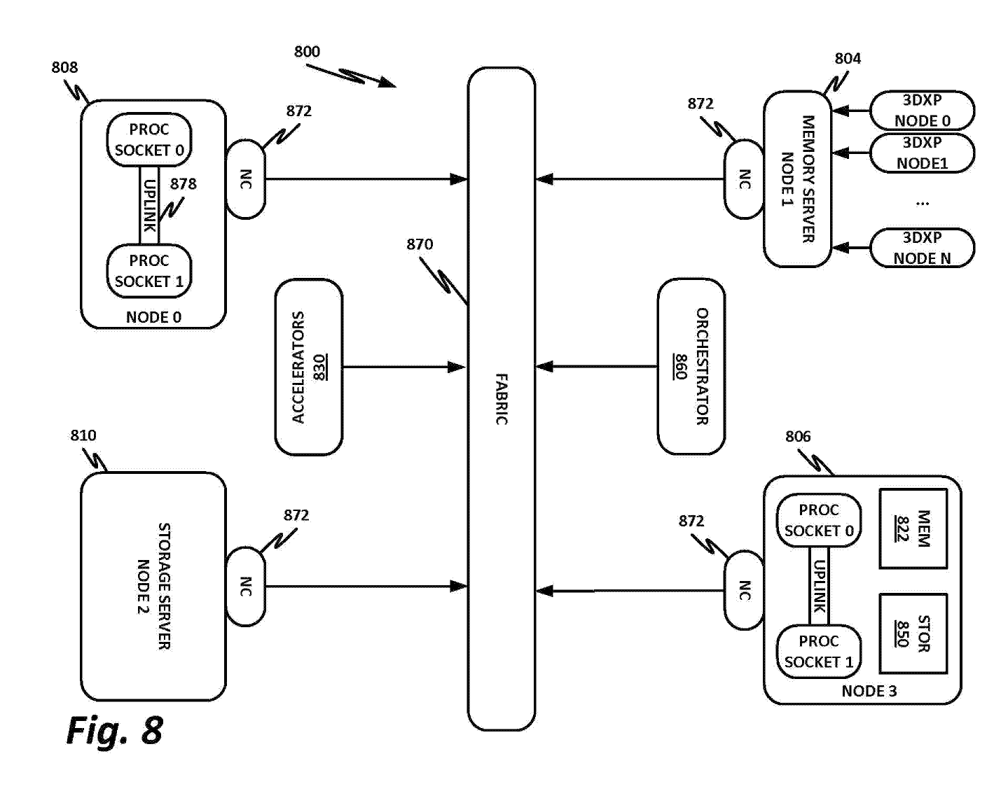

FIG. 8 is a block diagram of an end-user computing device 800, according to one or more examples of the present specification. Embodiments of an end-user computing device disclosed herein may be adapted or configured to provide the method of providing a multibank cache with dynamic cache virtualization, according to the teachings of the present specification. As above, computing device 800 may provide, as appropriate, cloud service, HPC, telecommunication services, enterprise data center services, or any other compute services that benefit from a computing device 800.

In this example, a fabric 870 is provided to interconnect various aspects of computing device 800. Fabric 870 may be the same as fabric 770 of FIG. 7, or may be a different fabric. As above, fabric 870 may be provided by any suitable interconnect technology. In this example, Intel® Omni-Path™ is used as an illustrative and nonlimiting example.

As illustrated, computing device 800 includes a number of logic elements forming a plurality of nodes. It should be understood that each node may be provided by a physical server, a group of servers, or other hardware. Each server may be running one or more virtual machines as appropriate to its application.

Node 0 808 is a processing node including a processor socket 0 and processor socket 1. The processors may be, for example, Intel® Xeon™ processors with a plurality of cores, such as 4 or 8 cores. Node 0 808 may be configured to provide network or workload functions, such as by hosting a plurality of virtual machines or virtual appliances.

Onboard communication between processor socket 0 and processor socket 1 may be provided by an onboard uplink 878. This may provide a very high speed, short-length interconnect between the two processor sockets, so that virtual machines running on node 0 808 can communicate with one another at very high speeds. To facilitate this communication, a virtual switch (vSwitch) may be provisioned on node 0 808, which may be considered to be part of fabric 870.

Node 0 808 connects to fabric 870 via a network controller (NC) 872. NC 872 provides physical interface (a PHY level) and logic to communicatively couple a device to a fabric. For example, NC 872 may be a NIC to communicatively couple to an Ethernet fabric or a host fabric interface (HFI) to communicatively couple to a clustering fabric such as an Intel® Omni-Path™, by way of illustrative and nonlimiting example. In some examples, communication with fabric 870 may be tunneled, such as by providing UPI tunneling over Omni-Path™.

Because computing device 800 may provide many functions in a distributed fashion that in previous generations were provided onboard, a highly capable NC 872 may be provided. NC 872 may operate at speeds of multiple gigabits per second, and in some cases may be tightly coupled with node 0 808. For example, in some embodiments, the logic for NC 872 is integrated directly with the processors on an SoC. This provides very high speed communication between NC 872 and the processor sockets, without the need for intermediary bus devices, which may introduce additional latency into the fabric. However, this is not to imply that embodiments where NC 872 is provided over a traditional bus are to be excluded. Rather, it is expressly anticipated that in some examples, NC 872 may be provided on a bus, such as a PCIe bus, which is a serialized version of PCI that provides higher speeds than traditional PCI. Throughout computing device 800, various nodes may provide different types of NCs 872, such as onboard NCs and plug-in NCs. It should also be noted that certain blocks in an SoC may be provided as IP blocks that can be “dropped” into an integrated circuit as a modular unit. Thus, NC 872 may in some cases be derived from such an IP block.

Note that in “the network is the device” fashion, node 0 808 may provide limited or no onboard memory or storage. Rather, node 0 808 may rely primarily on distributed services, such as a memory server and a networked storage server. Onboard, node 0 808 may provide only sufficient memory and storage to bootstrap the device and get it communicating with fabric 870. This kind of distributed architecture is possible because of the very high speeds of contemporary data centers, and may be advantageous because there is no need to over-provision resources for each node. Rather, a large pool of high speed or specialized memory may be dynamically provisioned between a number of nodes, so that each node has access to a large pool of resources, but those resources do not sit idle when that particular node does not need them.

In this example, a node 1 memory server 804 and a node 2 storage server 810 provide the operational memory and storage capabilities of node 0 808. For example, memory server node 1 804 may provide remote direct memory access (RDMA), whereby node 0 808 may access memory resources on node 1 804 via fabric 870 in a direct memory access fashion, similar to how it would access its own onboard memory. The memory provided by memory server 804 may be traditional memory, such as double data rate type 3 (DDR3) DRAM, which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 808, a storage server node 2 810 may be provided. Storage server 810 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 808 may access memory from memory server 804 and store results on storage provided by storage server 810. Each of these devices couples to fabric 870 via a NC 872, which provides fast communication that makes these technologies possible.

By way of further illustration, node 3 806 is also depicted. Node 3 806 also includes a NC 872, along with two processor sockets internally connected by an uplink. However, unlike node 0 808, node 3 806 includes its own onboard memory 822 and storage 850. Thus, node 3 806 may be configured to perform its functions primarily onboard, and may not be required to rely upon memory server 804 and storage server 810. However, in appropriate circumstances, node 3 806 may supplement its own onboard memory 822 and storage 850 with distributed resources similar to node 0 808.

Computing device 800 may also include accelerators 830. These may provide various accelerated functions, including hardware or co-processor acceleration for functions such as packet processing, encryption, decryption, compression, decompression, network security, or other accelerated functions in the data center. In some examples, accelerators 830 may include deep learning accelerators that may be directly attached to one or more cores in nodes such as node 0 808 or node 3 806. Examples of such accelerators can include, by way of nonlimiting example, Intel® QuickData Technology (QDT), Intel® QuickAssist Technology (QAT), Intel® Direct Cache Access (DCA), Intel® Extended Message Signaled Interrupt (MSI-X), Intel® Receive Side Coalescing (RSC), and other acceleration technologies.

In other embodiments, an accelerator could also be provided as an application-specific integrated circuit (ASIC), field-programmable gate array (FPGA), co-processor, graphics processing unit (GPU), digital signal processor (DSP), or other processing entity, which may optionally be tuned or configured to provide the accelerator function.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), PFM (e.g., Intel® 3D Crosspoint™), external storage, RAID, RAIN, NAS, optical storage, tape drive, backup system, cloud storage, or any combination of the foregoing by way of nonlimiting example. Such a medium could also include instructions programmed into an FPGA, or encoded in hardware on an ASIC or processor.

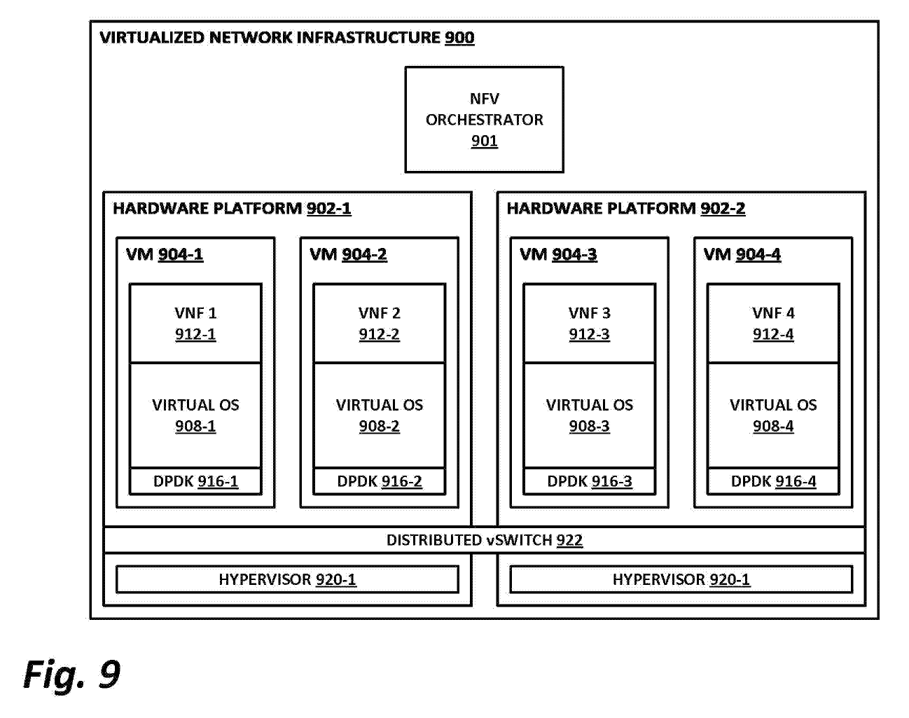

FIG. 9 is a block diagram of a network function virtualization (NFV) infrastructure 900, according to one or more examples of the present specification. Embodiments of an NFV infrastructure disclosed herein may be adapted or configured to provide the method of providing a multibank cache with dynamic cache virtualization, according to the teachings of the present specification.

NFV is an aspect of network virtualization that is generally considered distinct from, but that can still interoperate with SDN. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancer VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 400. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

Like SDN, NFV is a subset of network virtualization. In a virtualized network, certain portions of the network may rely on SDN, while other portions (or the same portions) may rely on NFV.

In the example of FIG. 9, an NFV orchestrator 901 manages a number of the VNFs 912 running on an NFVI 900. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 901 a valuable system resource. Note that NFV orchestrator 901 may provide a browser-based or graphical configuration interface, and in some embodiments may be integrated with SDN orchestration functions.

Note that NFV orchestrator 901 itself may be virtualized (rather than a special-purpose hardware appliance). NFV orchestrator 901 may be integrated within an existing SDN system, wherein an operations support system (OSS) manages the SDN. This may interact with cloud resource management systems (e.g., OpenStack) to provide NFV orchestration. An NFVI 900 may include the hardware, software, and other infrastructure to enable VNFs to run. This may include a hardware platform 902 on which one or more VMs 904 may run. For example, hardware platform 902-1 in this example runs VMs 904-1 and 904-2. Hardware platform 902-2 runs VMs 904-3 and 904-4. Each hardware platform may include a hypervisor 920, virtual machine manager (VMM), or similar function, which may include and run on a native (bare metal) operating system, which may be minimal so as to consume very few resources.

Hardware platforms 902 may be or comprise a rack or several racks of blade or slot servers (including, e.g., processors, memory, and storage), one or more data centers, other hardware resources distributed across one or more geographic locations, hardware switches, or network interfaces. An NFVI 900 may also include the software architecture that enables hypervisors to run and be managed by NFV orchestrator 901.

Running on NFVI 900 are a number of VMs 904, each of which in this example is a VNF providing a virtual service appliance. Each VM 904 in this example includes an instance of the Data Plane Development Kit (DVDK), a virtual operating system 908, and an application providing the VNF 912.

Virtualized network functions could include, as nonlimiting and illustrative examples, firewalls, intrusion detection systems, load balancers, routers, session border controllers, DPI services, network address translation (NAT) modules, or call security association.

The illustration of FIG. 9 shows that a number of VNFs 904 have been provisioned and exist within NFVI 900. This figure does not necessarily illustrate any relationship between the VNFs and the larger network, or the packet flows that NFVI 900 may employ.

The illustrated Data Plane Development Kit (DPDK) instances 916 provide a set of highly-optimized libraries for communicating across a virtual switch (vSwitch) 922. Like VMs 904, vSwitch 922 is provisioned and allocated by a hypervisor 920. The hypervisor uses a network interface to connect the hardware platform to the data center fabric (e.g., an HFI). This HFI may be shared by all VMs 904 running on a hardware platform 902. Thus, a vSwitch may be allocated to switch traffic between VMs 904. The vSwitch may be a pure software vSwitch (e.g., a shared memory vSwitch), which may be optimized so that data are not moved between memory locations, but rather, the data may stay in one place, and pointers may be passed between VMs 904 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 922 is illustrated, wherein vSwitch 922 is shared between two or more physical hardware platforms 902.

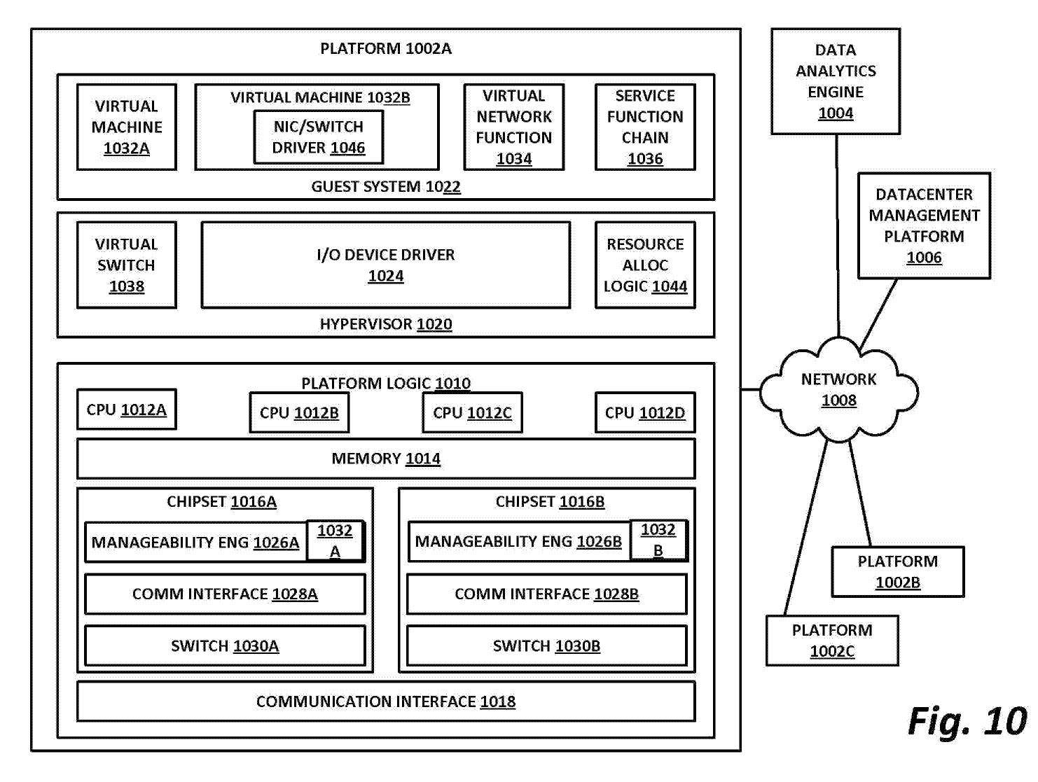

FIG. 10 is a block diagram of components of a computing platform 1002A, according to one or more examples of the present specification. Embodiments of a computing platform disclosed herein may be adapted or configured to provide the method of providing a multibank cache with dynamic cache virtualization, according to the teachings of the present specification.

In the embodiment depicted, hardware platforms 1002A, 1002B, and 1002C, along with a data center management platform 1006 and data analytics engine 1004 are interconnected via network 1008. In other embodiments, a computer system may include any suitable number of (i.e., one or more) platforms, including hardware, software, firmware, and other components. In some embodiments (e.g., when a computer system only includes a single platform), all or a portion of the system management platform 1006 may be included on a platform 1002. A platform 1002 may include platform logic 1010 with one or more CPUs 1012, memories 1014 (which may include any number of different modules), chipsets 1016, communication interfaces 1018, and any other suitable hardware and/or software to execute a hypervisor 1020 or other operating system capable of executing workloads associated with applications running on platform 1002. In some embodiments, a platform 1002 may function as a host platform for one or more guest systems 1022 that invoke these applications. Platform 1002A may represent any suitable computing environment, such as an HPC environment, a data center, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 1006, hypervisor 1020, or other operating system) of computer platform 1002A may assign hardware resources of platform logic 1010 to perform workloads in accordance with the stress information. In some embodiments, self-diagnostic capabilities may be combined with the stress monitoring to more accurately determine the health of the hardware resources. Each platform 1002 may include platform logic 1010. Platform logic 1010 comprises, among other logic enabling the functionality of platform 1002, one or more CPUs 1012, memory 1014, one or more chipsets 1016, and communication interfaces 1028. Although three platforms are illustrated, computer platform 1002A may be interconnected with any suitable number of platforms. In various embodiments, a platform 1002 may reside on a circuit board that is installed in a chassis, rack, or other suitable structure that comprises multiple platforms coupled together through network 1008 (which may comprise, e.g., a rack or backplane switch).

CPUs 1012 may each comprise any suitable number of processor cores and supporting logic (e.g., uncores). The cores may be coupled to each other, to memory 1014, to at least one chipset 1016, and/or to a communication interface 1018, through one or more controllers residing on CPU 1012 and/or chipset 1016. In particular embodiments, a CPU 1012 is embodied within a socket that is permanently or removably coupled to platform 1002A. Although four CPUs are shown, a platform 1002 may include any suitable number of CPUs.

Memory 1014 may comprise any form of volatile or nonvolatile memory including, without limitation, magnetic media (e.g., one or more tape drives), optical media, random access memory (RAM), ROM, flash memory, removable media, or any other suitable local or remote memory component or components. Memory 1014 may be used for short, medium, and/or long term storage by platform 1002A. Memory 1014 may store any suitable data or information utilized by platform logic 1010, including software embedded in a computer-readable medium, and/or encoded logic incorporated in hardware or otherwise stored (e.g., firmware). Memory 1014 may store data that is used by cores of CPUs 1012. In some embodiments, memory 1014 may also comprise storage for instructions that may be executed by the cores of CPUs 1012 or other processing elements (e.g., logic resident on chipsets 1016) to provide functionality associated with the manageability engine 1026 or other components of platform logic 1010. A platform 1002 may also include one or more chipsets 1016 comprising any suitable logic to support the operation of the CPUs 1012. In various embodiments, chipset 1016 may reside on the same die or package as a CPU 1012 or on one or more different dies or packages. Each chipset may support any suitable number of CPUs 1012. A chipset 1016 may also include one or more controllers to couple other components of platform logic 1010 (e.g., communication interface 1018 or memory 1014) to one or more CPUs. In the embodiment depicted, each chipset 1016 also includes a manageability engine 1026. Manageability engine 1026 may include any suitable logic to support the operation of chipset 1016. In a particular embodiment, a manageability engine 1026 (which may also be referred to as an innovation engine) is capable of collecting real-time telemetry data from the chipset 1016, the CPU(s) 1012 and/or memory 1014 managed by the chipset 1016, other components of platform logic 1010, and/or various connections between components of platform logic 1010. In various embodiments, the telemetry data collected includes the stress information described herein.

In various embodiments, a manageability engine 1026 operates as an out-of-band asynchronous compute agent which is capable of interfacing with the various elements of platform logic 1010 to collect telemetry data with no or minimal disruption to running processes on CPUs 1012. For example, manageability engine 1026 may comprise a dedicated processing element (e.g., a processor, controller, or other logic) on chipset 1016, which provides the functionality of manageability engine 1026 (e.g., by executing software instructions), thus conserving processing cycles of CPUs 1012 for operations associated with the workloads performed by the platform logic 1010. Moreover the dedicated logic for the manageability engine 1026 may operate asynchronously with respect to the CPUs 1012 and may gather at least some of the telemetry data without increasing the load on the CPUs.

A manageability engine 1026 may process telemetry data it collects (specific examples of the processing of stress information are provided herein). In various embodiments, manageability engine 1026 reports the data it collects and/or the results of its processing to other elements in the computer system, such as one or more hypervisors 1020 or other operating systems and/or system management software (which may run on any suitable logic such as system management platform 1006). In particular embodiments, a critical event such as a core that has accumulated an excessive amount of stress may be reported prior to the normal interval for reporting telemetry data (e.g., a notification may be sent immediately upon detection).

Additionally, manageability engine 1026 may include programmable code configurable to set which CPU(s) 1012 a particular chipset 1016 manages and/or which telemetry data may be collected.

Chipsets 1016 also each include a communication interface 1028. Communication interface 1028 may be used for the communication of signaling and/or data between chipset 1016 and one or more I/O devices, one or more networks 1008, and/or one or more devices coupled to network 1008 (e.g., system management platform 1006). For example, communication interface 1028 may be used to send and receive network traffic such as data packets. In a particular embodiment, a communication interface 1028 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, WiFi, or other suitable standard. A NIC may include one or more physical ports that may couple to a cable (e.g., an Ethernet cable). A NIC may enable communication between any suitable element of chipset 1016 (e.g., manageability engine 1026 or switch 1030) and another device coupled to network 1008. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 1028 may allow communication of data (e.g., between the manageability engine 1026 and the data center management platform 1006) associated with management and monitoring functions performed by manageability engine 1026. In various embodiments, manageability engine 1026 may utilize elements (e.g., one or more NICs) of communication interfaces 1028 to report the telemetry data (e.g., to system management platform 1006) in order to reserve usage of NICs of communication interface 1018 for operations associated with workloads performed by platform logic 1010.

Switches 1030 may couple to various ports (e.g., provided by NICs) of communication interface 1028 and may switch data between these ports and various components of chipset 1016 (e.g., one or more Peripheral Component Interconnect Express (PCIe) lanes coupled to CPUs 1012). Switches 1030 may be a physical or virtual (i.e., software) switch.

Platform logic 1010 may include an additional communication interface 1018. Similar to communication interfaces 1028, communication interfaces 1018 may be used for the communication of signaling and/or data between platform logic 1010 and one or more networks 1008 and one or more devices coupled to the network 1008. For example, communication interface 1018 may be used to send and receive network traffic such as data packets. In a particular embodiment, communication interfaces 1018 comprise one or more physical NICs. These NICs may enable communication between any suitable element of platform logic 1010 (e.g., CPUs 1012 or memory 1014) and another device coupled to network 1008 (e.g., elements of other platforms or remote computing devices coupled to network 1008 through one or more networks).

Platform logic 1010 may receive and perform any suitable types of workloads. A workload may include any request to utilize one or more resources of platform logic 1010, such as one or more cores or associated logic. For example, a workload may comprise a request to instantiate a software component, such as an I/O device driver 1024 or guest system 1022; a request to process a network packet received from a virtual machine 1032 or device external to platform 1002A (such as a network node coupled to network 1008); a request to execute a process or thread associated with a guest system 1022, an application running on platform 1002A, a hypervisor 1020 or other operating system running on platform 1002A; or other suitable processing request.

A virtual machine 1032 may emulate a computer system with its own dedicated hardware. A virtual machine 1032 may run a guest operating system on top of the hypervisor 1020. The components of platform logic 1010 (e.g., CPUs 1012, memory 1014, chipset 1016, and communication interface 1018) may be virtualized such that it appears to the guest operating system that the virtual machine 1032 has its own dedicated components.

A virtual machine 1032 may include a virtualized NIC (vNIC), which is used by the virtual machine as its network interface. A vNIC may be assigned a media access control (MAC) address or other identifier, thus allowing multiple virtual machines 1032 to be individually addressable in a network.

VNF 1034 may comprise a software implementation of a functional building block with defined interfaces and behavior that can be deployed in a virtualized infrastructure. In particular embodiments, a VNF 1034 may include one or more virtual machines 1032 that collectively provide specific functionalities (e.g., WAN optimization, virtual private network (VPN) termination, firewall operations, load-balancing operations, security functions, etc.). A VNF 1034 running on platform logic 1010 may provide the same functionality as traditional network components implemented through dedicated hardware. For example, a VNF 1034 may include components to perform any suitable NFV workloads, such as virtualized evolved packet core (vEPC) components, mobility management entities, 3rd Generation Partnership Project (3GPP) control and data plane components, etc.

SFC 1036 is a group of VNFs 1034 organized as a chain to perform a series of operations, such as network packet processing operations. Service function chaining may provide the ability to define an ordered list of network services (e.g. firewalls, load balancers) that are stitched together in the network to create a service chain.

A hypervisor 1020 (also known as a virtual machine monitor) may comprise logic to create and run guest systems 1022. The hypervisor 1020 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 1010. Services of hypervisor 1020 may be provided by virtualizing in software or through hardware assisted resources that require minimal software intervention, or both. Multiple instances of a variety of guest operating systems may be managed by the hypervisor 1020. Each platform 1002 may have a separate instantiation of a hypervisor 1020.

Hypervisor 1020 may be a native or bare metal hypervisor that runs directly on platform logic 1010 to control the platform logic and manage the guest operating systems. Alternatively, hypervisor 1020 may be a hosted hypervisor that runs on a host operating system and abstracts the guest operating systems from the host operating system. Hypervisor 1020 may include a virtual switch 1038 that may provide virtual switching and/or routing functions to virtual machines of guest systems 1022. The virtual switch 1038 may comprise a logical switching fabric that couples the vNICs of the virtual machines 1032 to each other, thus creating a virtual network through which virtual machines may communicate with each other.

Virtual switch 1038 may comprise a software element that is executed using components of platform logic 1010. In various embodiments, hypervisor 1020 may be in communication with any suitable entity (e.g., a SDN controller) which may cause hypervisor 1020 to reconfigure the parameters of virtual switch 1038 in response to changing conditions in platform 1002 (e.g., the addition or deletion of virtual machines 1032 or identification of optimizations that may be made to enhance performance of the platform).

Hypervisor 1020 may also include resource allocation logic 1044, which may include logic for determining allocation of platform resources based on the telemetry data (which may include stress information). Resource allocation logic 1044 may also include logic for communicating with various components of platform logic 1010 entities of platform 1002A to implement such optimization, such as components of platform logic 1010.

Any suitable logic may make one or more of these optimization decisions. For example, system management platform 1006; resource allocation logic 1044 of hypervisor 1020 or other operating system; or other logic of computer platform 1002A may be capable of making such decisions. In various embodiments, the system management platform 1006 may receive telemetry data from and manage workload placement across multiple platforms 1002. The system management platform 1006 may communicate with hypervisors 1020 (e.g., in an out-of-band manner) or other operating systems of the various platforms 1002 to implement workload placements directed by the system management platform.

The elements of platform logic 1010 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a GTL bus.

Elements of the computer platform 1002A may be coupled together in any suitable manner such as through one or more networks 1008. A network 1008 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

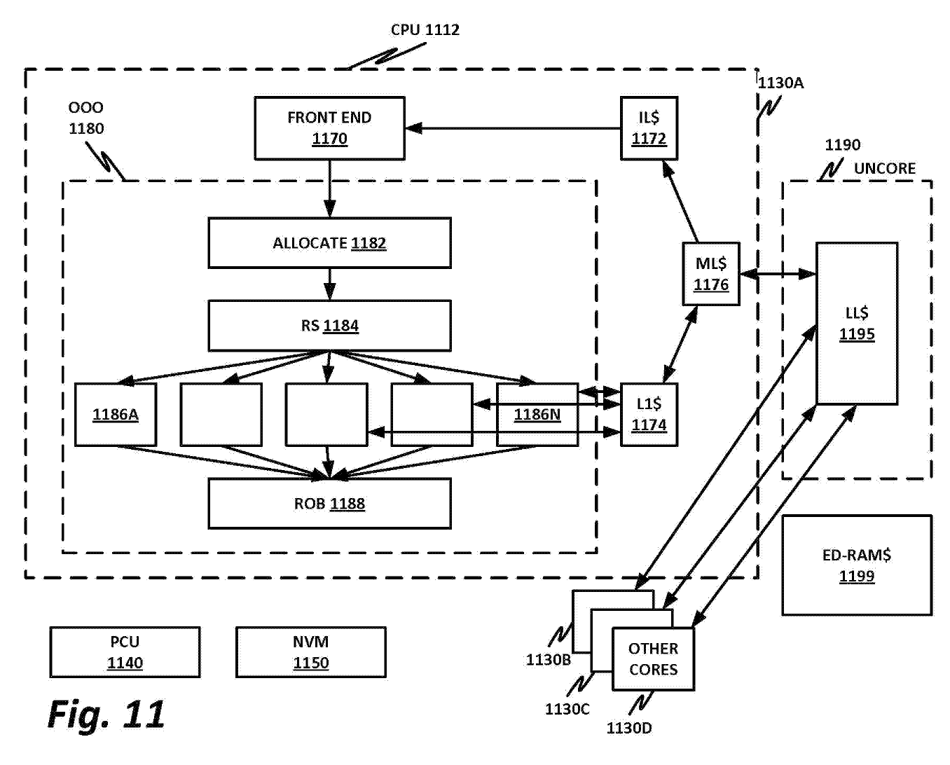

FIG. 11 illustrates a block diagram of a CPU 1112, according to one or more examples of the present specification. Embodiments of a CPU disclosed herein may be adapted or configured to provide the method of providing a multibank cache with dynamic cache virtualization, according to the teachings of the present specification.

Although CPU 1112 depicts a particular configuration, the cores and other components of CPU 1112 may be arranged in any suitable manner. CPU 1112 may comprise any processor or processing device, such as a microprocessor, an embedded processor, a DSP, a network processor, an application processor, a co-processor, an SoC, or other device to execute code. CPU 1112, in the depicted embodiment, includes four processing elements (cores 1130 in the depicted embodiment), which may include asymmetric processing elements or symmetric processing elements. However, CPU 1112 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 1130A includes an out-of-order processor that has a front end unit 1170 used to fetch incoming instructions, perform various processing (e.g. caching, decoding, branch predicting, etc.) and passing instructions/operations along to an out-of-order (OOO) engine. The OOO engine performs further processing on decoded instructions.

A front end 1170 may include a decode module coupled to fetch logic to decode fetched elements. Fetch logic, in one embodiment, includes individual sequencers associated with thread slots of cores 1130. Usually a core 1130 is associated with a first ISA, which defines/specifies instructions executable on core 1130. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 1130, in one embodiment, recognize the same ISA (or a subset thereof). Alternatively, in a heterogeneous core environment, a decoder of one or more cores (e.g., core 1130B) may recognize a second ISA (either a subset of the first ISA or a distinct ISA).

In the embodiment depicted, the 000 engine includes an allocate unit 1182 to receive decoded instructions, which may be in the form of one or more micro-instructions or uops, from front end unit 1170, and allocate them to appropriate resources such as registers and so forth. Next, the instructions are provided to a reservation station 1184, which reserves resources and schedules them for execution on one of a plurality of execution units 1186A-1186N. Various types of execution units may be present, including, for example, arithmetic logic units (ALUs), load and store units, vector processing units (VPUs), floating point execution units, among others. Results from these different execution units are provided to a reorder buffer (ROB) 1188, which take unordered results and return them to correct program order.

In the embodiment depicted, both front end unit 1170 and 000 engine 1180 are coupled to different levels of a memory hierarchy. This memory hierarchy may include various levels of cache. The cache is a fast memory structure that is often multilayered. In common practice, cache is much faster than main memory (often two to three orders of magnitude faster), and includes cache ways that map to address spaces within main memory. Cache design may be driven by the principle that faster is generally more expensive, and larger is generally slower. Thus, in some cases, cache is divided into multiple levels. For example, a small, very fast, and relatively expensive level 1 (L1) cache may service an individual core. A larger, somewhat less expensive, but also slower level 2 (L2) cache may service a plurality of cores within the same CPU socket. An even larger, slower, and less expensive layer 3 (L3) cache (also known as “last level cache” (LLC)) may be located on the motherboard, and may service multiple CPU sockets within the same system. These are illustrated as nonlimiting examples only, and it should be understood that other cache configurations are also possible.

Specifically shown is an instruction level cache 1172, that in turn couples to a mid-level cache 1176, that in turn couples to an LLC 1195. In one embodiment, last level cache 1195 is implemented in an on-chip (sometimes referred to as uncore) unit 1190. Uncore 1190 may communicate with system memory 1199, which, in the illustrated embodiment, is implemented via embedded DRAM (eDRAM). The various execution units 1186 within OOO engine 1180 are in communication with a first level cache 1174 that also is in communication with mid-level cache 1176. Additional cores 1130B-1130D may couple to last level cache 1195 as well. L1 is on the individual core, L2 services multiple cores, and L3 is on the motherboard.

In particular embodiments, uncore 1190 may be in a voltage domain and/or a frequency domain that is separate from voltage domains and/or frequency domains of the cores. That is, uncore 1190 may be powered by a supply voltage that is different from the supply voltages used to power the cores and/or may operate at a frequency that is different from the operating frequencies of the cores.

CPU 1112 may also include a power control unit (PCU) 1140. In various embodiments, PCU 1140 may control the supply voltages and the operating frequencies applied to each of the cores (on a per-core basis) and to the uncore. PCU 1140 may also instruct a core or uncore to enter an idle state (where no voltage and clock are supplied) when not performing a workload.

In various embodiments, PCU 1140 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 1140 may detect stress characteristics at any suitable interval.

In various embodiments, PCU 1140 is a component that is discrete from the cores 1130. In particular embodiments, PCU 1140 runs at a clock frequency that is different from the clock frequencies used by cores 1130. In some embodiments where the PCU is a microcontroller, PCU 1140 executes instructions according to an ISA that is different from an ISA used by cores 1130.

In various embodiments, CPU 1112 may also include a nonvolatile memory 1150 to store stress information (such as stress characteristics, incremental stress values, accumulated stress values, stress accumulation rates, or other stress information) associated with cores 1130 or uncore 1190, such that when power is lost, the stress information is maintained.

FIG. 12 is a block diagram of rack scale design (RSD) 1200, according to one or more examples of the present specification. Embodiments of RSD disclosed herein may be adapted or configured to provide the method of providing a multibank cache with dynamic cache virtualization, according to the teachings of the present specification.

In this example, RSD 1200 includes a single rack 1204, to illustrate certain principles of RSD. It should be understood that RSD 1200 may include many such racks, and that the racks need not be identical to one another. In some cases a multipurpose rack such as rack 1204 may be provided, while in other examples, single-purpose racks may be provided. For example, rack 1204 may be considered a highly inclusive rack that includes resources that may be used to allocate a large number of composite nodes. On the other hand, other examples could include a rack dedicated solely to compute sleds, storage sleds, memory sleds, and other resource types, which together can be integrated into composite nodes. Thus, rack 1204 of FIG. 12 should be understood to be a nonlimiting example of a rack that may be used in an RSD 1200.

In the example of FIG. 12, rack 1204 may be a standard rack with an external width of approximately 23.6 inches and a height of 78.74 inches. In common usage, this is referred to as a “42 U rack.” However, rack 1204 need not conform to the “rack unit” standard. Rather, rack 1204 may include a number of chassis that are optimized for their purposes.

Rack 1204 may be marketed and sold as a monolithic unit, with a number of line replaceable units (LRUs) within each chassis. The LRUs in this case may be sleds, and thus can be easily swapped out when a replacement needs to be made.

In this example, rack 1204 includes a power chassis 1210, a storage chassis 1216, three compute chassis (1224-1, 1224-2, and 1224-3), a 3-D Crosspoint™ (3DXP) chassis 1228, an accelerator chassis 1230, and a networking chassis 1234. Each chassis may include one or more LRU sleds holding the appropriate resources. For example, power chassis 1210 includes a number of hot pluggable power supplies 1212, which may provide shared power to rack 1204. In other embodiments, some sled chassis may also include their own power supplies, depending on the needs of the embodiment.

Storage chassis 1216 includes a number of storage sleds 1218. Compute chassis 1224 each contain a number of compute sleds 1220. 3DXP chassis 1228 may include a number of 3DXP sleds 1226, each hosting a 3DXP memory server. And accelerator chassis 1230 may host a number of accelerators, such as Intel® Quick Assist™ technology (QAT), FPGAs, ASICs, or other accelerators of the same or different types. Accelerators within accelerator chassis 1230 may be the same type or of different types according to the needs of a particular embodiment.

Over time, the various LRUs within rack 1204 may become damaged, outdated, or may experience functional errors. As this happens, LRUs may be pulled and replaced with compatible LRUs, thus allowing the rack to continue full scale operation.

FIG. 13 is a block diagram of a software-defined infrastructure (SDI) data center 1300, according to one or more examples of the present specification. Embodiments of an SDI data center disclosed herein may be adapted or configured to provide the method of providing a multibank cache with dynamic cache virtualization, according to the teachings of the present specification. Certain applications hosted within SDI data center 1300 may employ a set of resources to achieve their designated purposes, such as processing database queries, serving web pages, or providing computer intelligence.

Certain applications tend to be sensitive to a particular subset of resources. For example, SAP HANA is an in-memory, column-oriented relational database system. A SAP HANA database may use processors, memory, disk, and fabric, while being most sensitive to memory and processors. In one embodiment, composite node 1302 includes one or more cores 1310 that perform the processing function. Node 1302 may also include caching agents 1306 that provide access to high speed cache. One or more applications 1314 run on node 1302, and communicate with the SDI fabric via HFI 1318. Dynamically provisioning resources to node 1302 may include selecting a set of resources and ensuring that the quantities and qualities provided meet required performance indicators, such as SLAs and quality of service (QoS). Resource selection and allocation for application 1314 may be performed by a resource manager, which may be implemented within orchestration and system software stack 1322. By way of nonlimiting example, throughout this specification the resource manager may be treated as though it can be implemented separately or by an orchestrator. Note that many different configurations are possible.

In an SDI data center, applications may be executed by a composite node such as node 1302 that is dynamically allocated by SDI manager 1380. Such nodes are referred to as composite nodes because they are not nodes where all of the resources are necessarily collocated. Rather, they may include resources that are distributed in different parts of the data center, dynamically allocated, and virtualized to the specific application 1314.

In this example, memory resources from three memory sleds from memory rack 1330 are allocated to node 1302, storage resources from four storage sleds from storage rack 1334 are allocated, and additional resources from five resource sleds from resource rack 1336 are allocated to application 1314 running on composite node 1302. All of these resources may be associated to a particular compute sled and aggregated to create the composite node. Once the composite node is created, the operating system may be booted in node 1302, and the application may start running using the aggregated resources as if they were physically collocated resources. As described above, HFI 1318 may provide certain interfaces that enable this operation to occur seamlessly with respect to node 1302.

As a general proposition, the more memory and compute resources that are added to a database processor, the better throughput it can achieve. However, this is not necessarily true for the disk or fabric. Adding more disk and fabric bandwidth may not necessarily increase the performance of the SAP HANA database beyond a certain threshold.

SDI data center 1300 may address the scaling of resources by mapping an appropriate amount of offboard resources to the application based on application requirements provided by a user or network administrator or directly by the application itself. This may include allocating resources from various resource racks, such as memory rack 1330, storage rack 1334, and resource rack 1336.

In an example, SDI controller 1380 also includes a resource protection engine (RPE) 1382, which is configured to assign permission for various target resources to disaggregated compute resources (DRCs) that are permitted to access them. In this example, the resources are expected to be enforced by an HFI servicing the target resource.

In certain embodiments, elements of SDI data center 1300 may be adapted or configured to operate with the disaggregated telemetry model of the present specification.

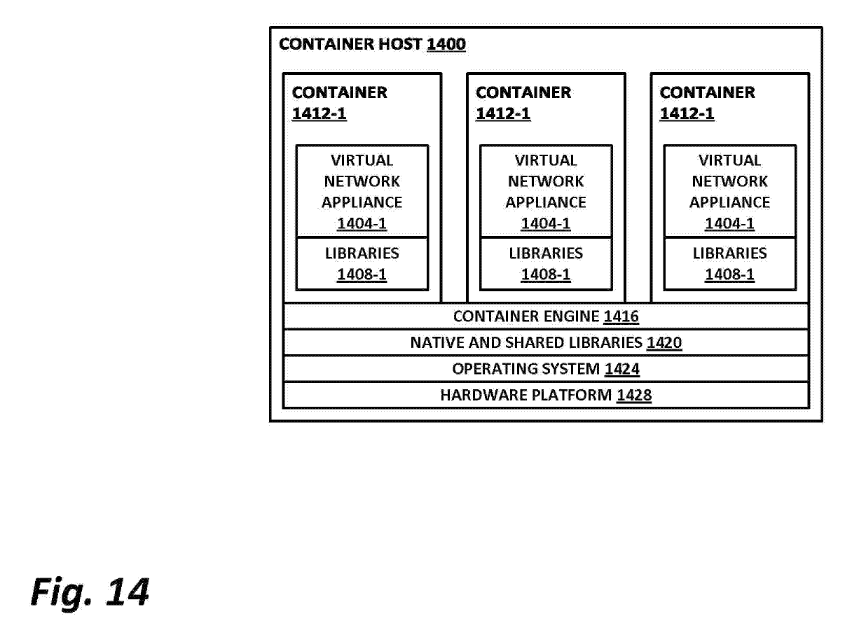

FIG. 14 is a block diagram of a container host 1400, according to one or more examples of the present specification. Operating-system-level virtualization, also known as containerization, refers to an operating system feature in which the kernel allows the existence of multiple isolated user-space instances. Such instances, called containers, partitions, virtualization engines (VEs) or jails (FreeBSD jail or chroot jail), may look like real computers from the point of view of programs running in them. A computer program running on an ordinary operating system can see all resources (connected devices, files and folders, network shares, CPU power, quantifiable hardware capabilities) of that computer. Typically, programs running inside a container can only see the container's contents and devices assigned to the container.

Container computing as provided by container host 1400 is a response to some of the perceived limitations of network function virtualization. Specifically, some data centers are switching at least in part to containerized computing because of the relatively large overhead of a virtual machine versus the overhead of a container. Note that the present specification makes no attempt to judge the relative merits of container computing versus network function virtualization or the use of virtual machines, but rather illustrates both as computing architectures that may be deployed in a data center. The selection of the most appropriate architecture for a particular application is an exercise of skill that can be left to a system designer.

Container host 1400 may be a server apparatus that may be found in a data center, such as a dedicated enterprise data center, or a large-scale data center such as provided by a CSP. Container host 1400 may be thought of as a single computing device such as a rackmount server, blade server, or other device, with a hardware platform 1428. Hardware platform 1428 may include components such as a processor, memory, and appropriate interconnects such as a PCIe interconnect, an Intel® Quick Path Interconnect (QPI), data buses, BIOS, support hardware, coprocessors, and any other hardware necessary to operate container host 1400.

Container host 1400 may also include an operating system 1424 that runs on hardware platform 1428. Operating system 1424 may be, for example, a Linux operating system, a Windows operating system, or any other suitable operating system that provides containerized computing services.

Native and shared libraries 1420 may be provided, which may include system-level libraries that can be shared between a number of different containers on container host 1400. Note that the selection and operation of shared libraries is a nontrivial task, as one consideration in container computing is the ability of a container to maintain and manage its own set of libraries. However, native and shared libraries 1420 may at least include libraries necessary to operate operating system 1424, and to provide services to a container engine 1416.

Container engine 1416 may be one of several available container engines that are known, or that may be provided in the future as equivalents. For example, Microsoft Windows provides a container engine known as Docker. Some flavors of Linux provide a container engine known as Linux Containers (LXC), or an equivalent or associated engines. Other operating systems may provide other container engines 1416 as appropriate to a particular deployment.

Container host 1400 is designed to allow the deployment of a number of virtual appliances, such as virtual network appliances 1404 on a single host without the overhead of a dedicated VM. A dedicated VM has its own operating system, a full set of libraries, and may have a specifically allocated number of cores and memory for that VM. One of the intended benefits of a container host 1400 is to provide the isolation between virtual network appliances 1404 as provided in VMs, without necessarily requiring the full overhead of a VM. On container host 1400, a plurality of containers, such as container 1412-1, container 1412-2, and container 1412-3 can be provided. Containers 1412 are similar to VMs in that they provide “silos” wherein virtual appliances can be deployed and be isolated from one another. However, containers 1412 all share the same underlying hardware platform 1428, meaning that there is no need to allocate a specific number of cores or a specific size of memory to each container 1412. Rather, container engine 1416 and operating system 1424 together can load balance resources according to the demands of the different containers 1412. Note, however, that this does not preclude the allocation of a certain number of cores or a certain size of memory to a particular container. Containers 1412 also do not need to replicate the underlying operating system 1424 or native and shared libraries 1420, thus saving overhead relative to a VM that replicates those pieces.

Each container 1412 may include a number of local container libraries 1408, such as libraries 1408-1 on container 1412-1, libraries 1408-2 on container 1412-2, and libraries 1408-3 on container 1412-3. Libraries 1408 are owned by their respective containers, and thus changes to the libraries in one container do not affect the libraries in another container. Libraries 1408 is provided as a block to illustrate conceptually the use of different silos to isolate containers from one another, but this block is not limited specifically to shared object libraries, for example. Rather, libraries 1408 should be understood broadly to encompass shared object libraries, static libraries, binaries, tools, tool chains, and software stacks that support virtual network appliance 1404.

Virtual network appliance 1404 provides, usually, a single dedicated network function, which may be part of a service chain, or which may provide a workload service, such as a web server, e-mail server, or similar.

Because containers 1412 are isolated from one another, changes within a container 1412 do not affect other containers 1412. Furthermore, errors, corruption, or problems encountered within a container 1412 should not propagate to other containers 1412. Thus, ideally, the use of container host 1400 realizes the isolation benefits of virtualization without necessarily incurring the overhead.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of nonlimiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the figures may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of nonlimiting example, an optical drive (e.g., CD/DVD/Blu-Ray), a hard drive, a solid state drive, a flash memory, or other nonvolatile medium. A computer-readable medium could also include a medium such as a ROM, an FPGA or ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, DSP, microcontroller, or in any other suitable component, device, element, or object where appropriate and based on particular needs. A non-transitory storage medium herein is expressly intended to include any non-transitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically-coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, or unless required in a particular context, the order should be understood to be a nonlimiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in an SoC, including a CPU package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

Example Implementations

The following examples are provided by way of illustration.

Example 1 includes a computing system, comprising: a processor comprising one or more computing cores; a cache having n discrete cache banks of the same cache level; and a cache controller comprising n discrete cache buses to communicatively couple the cache controller to the cache, wherein the cache buses are of width b, and a cache access controller configured to: receive an access request for an object of size s, wherein s>b; divide the object into k chunks of size b or smaller; and transfer the object to or from the cache in one or more iterations, the iterations comprising transferring n chunks of size b or smaller in parallel via the cache buses.

Example 2 includes the computing system of example 1, wherein the n discrete cache banks are of substantially identical size.

Example 3 includes the computing system of example 1, wherein the cache buses are all of an identical size b.

Example 4 includes the computing system of example 1, wherein n=4.

Example 5 includes the computing system of example 1, wherein b=64 bytes.

Example 6 includes the computing system of example 1, wherein the cache controller further comprises an address translation circuit to compute an object physical address from a page base address and a page offset.

Example 7 includes the cache controller of example 6, wherein the address translation circuit is further to receive a page index and use the page index as an index into a page table to find the page base address.

Example 8 includes the cache controller of example 7, wherein the page offset is a physical base address of the object.

Example 9 includes the cache controller of example 6, wherein the address translation circuit is further to compute an object virtual address relative to a virtual machine, wherein the object virtual address comprises the page index and the page offset.

Example 10 includes the cache controller of example 9, wherein the address translation circuit is further to: receive an object access request from the virtual machine; and compute the object virtual address from an object base address and an object index.

Example 11 includes the cache controller of example 10, wherein computing the object base address comprises: hashing a VM identifier (VMID) of the VM and object type identifier (OBJ ID) of the object; using the hash as an index into an hash memory space ID (HMSID) table to retrieve an HMSID; and using the HMSID as an index into an object base address table to find the object base address.

Example 12 includes a cache controller, comprising: a processor interface to communicatively couple to one or more computing cores; a cache interface comprising n discrete cache buses of width b to communicatively couple to a cache having n cache banks of the same level; and cache access circuitry to: receive a cache access request to read from or write to the cache an object having a size s, wherein s>b; divide the object into k chunks, the chunks having a size b; and perform a cache access operation in one or more transactions, wherein the transactions comprise reading chunks of the object from or writing chunks of the object to a plurality of cache banks in parallel.

Example 13 includes the cache controller of example 12, wherein the n discrete cache banks are of substantially identical size.

Example 14 includes the cache controller of example 12, wherein the cache buses are all of an identical size b.

Example 15 includes the cache controller of example 12, wherein n=4.

Example 16 includes the cache controller of example 12, wherein b=64 bytes.

Example 17 includes the cache controller of example 12, further comprising an address translation circuit to compute an object physical address from a page base address and a page offset.

Example 18 includes the cache controller of example 17, wherein the address translation circuit is further to receive a page index and use the page index as an index into a page table to find the page base address.

Example 19 includes the cache controller of example 18, wherein the page offset is a physical base address of the object.

Example 20 includes the cache controller of example 17, wherein the address translation circuit is further to compute an object virtual address relative to a virtual machine, wherein the object virtual address comprises the page index and the page offset.

Example 21 includes the cache controller of example 20, wherein the address translation circuit is further to: receive an object access request from the virtual machine; and compute the object virtual address from an object base address and an object index.

Example 22 includes the cache controller of example 21, wherein computing the object base address comprises: hashing a VM identifier (VMID) of the VM and object type identifier (OBJ ID) of the object; using the hash as an index into a hash memory space ID (HMSID) table to retrieve an HMSID; and using the HMSID as an index into an object base address table to find the object base address.

Example 23 includes an intellectual property (IP) block comprising the cache controller of any of examples 12-22.

Example 24 includes an application-specific integrated circuit (ASIC) comprising the cache controller of any of examples 12-22.

Example 25 includes a field-programmable gate array (FPGA) provisioned to provide the cache controller of any of examples 12-22.

Example 26 includes an integrated circuit (IC) comprising the cache controller of any of examples 12-22.

Example 27 includes a processor comprising the IC Of example 26.

Example 28 includes a system-on-a-chip (SoC) comprising the processor of example 27.

Example 29 includes a method of controlling a cache, comprising: communicatively coupling to one or more computing cores; communicatively coupling a cache interface comprising n discrete cache buses of width b to a cache having n cache banks of the same level; and receiving a cache request to fetch or store an object having a size s, wherein s>b; dividing the object into k chunks of size b or smaller; and fetching or storing the object comprising one or more iterations of transferring n parallel chunks of the object via the n cache buses.

Example 30 includes the method of example 29, wherein the n discrete cache banks are of substantially identical size.

Example 31 includes the method of example 29, wherein the cache buses are all of an identical size b.

Example 32 includes the method of example 29, wherein n=4.

Example 33 includes the method of example 29, wherein b=64 bytes.

Example 34 includes the method of example 29, further comprising providing address translation to compute an object physical address from a page base address and a page offset.

Example 35 includes the method of example 34, further comprising receiving a page index and using the page index as an index into a page table to find the page base address.

Example 36 includes the method of example 35, wherein the page offset is a physical base address of the object.

Example 37 includes the method of example 29, further comprising computing an object virtual address relative to a virtual machine, wherein the object virtual address comprises the page index and the page offset.

Example 38 includes the method of example 37, further comprising: receiving an object access request from the virtual machine; and computing the object virtual address from an object base address and an object index.

Example 39 includes the method of example 38, wherein computing the object base address comprises: hashing a VM identifier (VMID) of the VM and object type identifier (OBJ ID) of the object; using the hash as an index into a hash memory space ID (HMSID) table to retrieve an HMSID; and using the HMSID as an index into an object base address table to find the object base address.

Example 40 includes an apparatus comprising means for performing the method of any of examples 29-39.

Example 41 includes the apparatus of example 40, wherein the means comprise an intellectual property (IP) block.

Example 42 includes the apparatus of example 40, wherein the means comprise an application-specific integrated circuit (ASIC).

Example 43 includes the apparatus of example 40, wherein the means comprise a field-programmable gate array (FPGA).

Example 44 includes the apparatus of example 40, wherein the means comprise an integrated circuit (IC).

Example 45 includes a processor comprising the IC Of example 44.

Example 46 includes a system-on-a-chip (SoC) comprising the processor of example 45.

Example 47 includes one or more tangible, non-transitory storage mediums having stored thereon directives to instruct or provision an apparatus to: communicatively couple to one or more computing cores; communicatively couple a cache interface comprising n discrete cache buses of width b to a cache having n cache banks of the same level; and receive a cache request to fetch or store an object having a size s, wherein s>b; divide the object into k chunks of size b or smaller; and access the cache to store or retrieve the object comprising one or more iterations of transferring n parallel chunks of the object via the n cache buses.

Example 48 includes the one or more tangible, non-transitory mediums of example 47, wherein the n discrete cache banks are of substantially identical size.

Example 49 includes the one or more tangible, non-transitory mediums of example 47, wherein the cache buses are all of an identical size b.

Example 50 includes the one or more tangible, non-transitory mediums of example 47, wherein n=4.

Example 51 includes the one or more tangible, non-transitory mediums of example 47, wherein b=64 bytes.

Example 52 includes the one or more tangible, non-transitory mediums of example 47, further comprising providing address translation to compute an object physical address from a page base address and a page offset.

Example 53 includes the one or more tangible, non-transitory mediums of example 52, further comprising receiving a page index and using the page index as an index into a page table to find the page base address.

Example 54 includes the one or more tangible, non-transitory mediums of example 53, wherein the page offset is a physical base address of the object.

Example 55 includes the one or more tangible, non-transitory mediums of example 47, further comprising computing an object virtual address relative to a virtual machine, wherein the object virtual address comprises the page index and the page offset.

Example 56 includes the one or more tangible, non-transitory mediums of example 55, wherein the directives are further to instruct or provision the device to: receive an object access request from the virtual machine; and compute the object virtual address from an object base address and an object index.

Example 57 includes the one or more tangible, non-transitory mediums of example 56, wherein computing the object base address comprises: hashing a VM identifier (VMID) of the VM and object type identifier (OBJ ID) of the object; using the hash as an index into a hash memory space ID (HMSID) table to retrieve an HMSID; and using the HMSID as an index into an object base address table to find the object base address.

Example 58 includes the one or more tangible, non-transitory mediums of any of examples 47-57, wherein the directives are to provision an intellectual property (IP) block.

Example 59 includes the one or more tangible, non-transitory mediums of any of examples 47-57, wherein the directives are to provision an application-specific integrated circuit (ASIC).

Example 60 includes the one or more tangible, non-transitory mediums of any of examples 47-57, wherein the directives are to provision a field-programmable gate array (FPGA).

Example 61 includes the one or more tangible, non-transitory mediums of any of examples 47-57, wherein the directives are to provision an integrated circuit (IC).

Example 62 includes the one or more tangible, non-transitory mediums of any of examples 47-57, wherein the directives are to provision a system-on-a-chip (SoC).

What is claimed is:

1. A computing system, comprising:
a processor comprising one or more computing cores;
a cache having n discrete cache banks of the same cache level; and
a cache controller comprising n discrete cache buses to communicatively couple the cache controller to the cache, wherein the cache buses are of width b, and a cache access controller configured to:
receive an access request for an object of size s, wherein s>b;
divide the object into k chunks of size b or smaller; and
transfer the object to or from the cache in one or more iterations, the iterations comprising transferring n chunks of size b or smaller in parallel via the cache buses.

2. The computing system of claim 1, wherein the n discrete cache banks are of substantially identical size.

3. The computing system of claim 1, wherein the cache buses are all of an identical size b.

4. The computing system of claim 1, wherein n=4.

5. The computing system of claim 1, wherein b=64 bytes.

6. The computing system of claim 1, wherein the cache controller further comprises an address translation circuit to compute an object physical address from a page base address and a page offset.

7. The cache controller of claim 6, wherein the address translation circuit is further to receive a page index and use the page index as an index into a page table to find the page base address.

8. The cache controller of claim 7, wherein the page offset is a physical base address of the object.

9. The cache controller of claim 6, wherein the address translation circuit is further to compute an object virtual address relative to a virtual machine, wherein the object virtual address comprises the page index and the page offset.

10. The cache controller of claim 9, wherein the address translation circuit is further to:
receive an object access request from the virtual machine; and
compute the object virtual address from an object base address and an object index.

11. The cache controller of claim 10, wherein computing the object base address comprises:
hashing a VM identifier (VMID) of the VM and object type identifier (OBJ ID) of the object;
using the hash as an index into a hash memory space ID (HMSID) table to retrieve an HMSID; and
using the HMSID as an index into an object base address table to find the object base address.

12. A cache controller, comprising:
a processor interface to communicatively couple to one or more computing cores;
a cache interface comprising n discrete cache buses of width b to communicatively couple to a cache having n cache banks of the same level; and
cache access circuitry to:
receive a cache access request to read from or write to the cache an object having a size s, wherein s>b;
divide the object into k chunks, the chunks having a size b; and
perform a cache access operation in one or more transactions, wherein the transactions comprise reading chunks of the object from or writing chunks of the object to a plurality of cache banks in parallel.

13. The cache controller of claim 12, further comprising an address translation circuit to compute an object physical address from a page base address and a page offset.

14. The cache controller of claim 13, wherein the address translation circuit is further to compute an object virtual address relative to a virtual machine, wherein the object virtual address comprises the page index and the page offset.

15. The cache controller of claim 14, wherein the address translation circuit is further to:
receive an object access request from the virtual machine; and
compute the object virtual address from an object base address and an object index.

16. The cache controller of claim 15, wherein computing the object base address comprises:
hashing a VM identifier (VMID) of the VM and object type identifier (OBJ ID) of the object;
using the hash as an index into a hash memory space ID (HMSID) table to retrieve an HMSID; and
using the HMSID as an index into an object base address table to find the object base address.

17. An intellectual property (IP) block comprising the cache controller of claim 12.

18. An application-specific integrated circuit (ASIC) comprising the cache controller of claim 12.

19. An integrated circuit (IC) comprising the cache controller of claim 12.

20. A processor comprising the IC Of claim 19.

21. A system-on-a-chip (SoC) comprising the processor of claim 20.

22. A method of controlling a cache, comprising:
communicatively coupling to one or more computing cores;
communicatively coupling a cache interface comprising n discrete cache buses of width b to a cache having n cache banks of the same level; and
receiving a cache request to fetch or store an object having a size s, wherein s>b;
dividing the object into k chunks of size b or smaller; and
fetching or storing the object comprising one or more iterations of transferring n parallel chunks of the object via the n cache buses.

23. The method of claim 22, further comprising computing an object virtual address relative to a virtual machine, wherein the object virtual address comprises the page index and the page offset.

24. The method of claim 23, further comprising:
receiving an object access request from the virtual machine; and
computing the object virtual address from an object base address and an object index.

25. The method of claim 24, wherein computing the object base address comprises:
hashing a VM identifier (VMID) of the VM and object type identifier (OBJ ID) of the object;
using the hash as an index into a hash memory space ID (HMSID) table to retrieve an HMSID; and
using the HMSID as an index into an object base address table to find the object base address.
